(19) United States
(12) Patent Application Publication
(10) Pub. No.: US 2026/0284973 A1
(43) Pub. Date: Sep. 24, 2026

(54) CARTRIDGE FOR 3D PRINTING IN A VOLUME AND METHODS AND SYSTEMS INCLUDING SAME

(71) Applicant: QUADRATIC 3D, INC., CHARLESTOWN, MA (US)

(72) Inventors: ERIK HINRICHSEN, WATERTOWN, MA (US); TALIN CALIKYAN, EAST GREENWICH, RI (US); RICHARD NELSON ROSE, CAMBRIDGE, MA (US); KAREN TWIETMEYER, BELMONT, MA (US); ELANGO KUMARASAMY, ARLINGTON, MA (US); SAMUEL N. SANDERS, ARLINGTON, MA (US)

(21) Appl. No.: 19/685,024

(22) Filed: May 21, 2026

Related U.S. Application Data
(63) Continuation of application No. PCT/US2024/057144, filed on Nov. 22, 2024.
(60) Provisional application No. 63/602,132, filed on Nov. 22, 2023.
(60) Provisional application No. 63/704,531, filed on Oct. 7, 2024.

(51) Int. Cl. B29C 64/255; B29C 64/124; B33Y 30/00

(52) U.S. Cl. CPC B29C 64/255; B29C 64/124; B33Y 30/00

(57) ABSTRACT

A cartridge for use in printing a three dimensional object in a volume of a photohardenable composition, the cartridge including: a rigid frame including a base and a plurality of structural members projecting upwardly from the base and a plurality of panels, the plurality of panels being in engagement with the frame to define a chamber for containing a volume of a photohardenable composition, wherein one or more of the panels is removably attached to the frame. A cartridge including a wall with absorbing beam blocking characteristics is also disclosed. Methods of forming a three dimensional object in a volume of a photohardenable composition, and systems for forming a three dimensional object in a volume of a photohardenable composition which methods and systems include a cartridge described herein are also disclosed.

### CROSS-REFERENCE TO RELATED APPLICATIONS

This application is a continuation of International Application No. PCT/US2024/057144 filed Nov. 22, 2024 which International Application claims priority to U.S. Provisional Patent Application No. 63/602,132 of Quadratic 3D, Inc. filed on Nov. 22, 2023 and U.S. Provisional Patent Application No. 63/704,531 of Quadratic 3D, Inc. filed on Oct. 7, 2024. Each of the foregoing applications is hereby incorporated herein by reference in its entirety for all purposes.

### TECHNICAL FIELD OF THE INVENTION

The present relates to the technical field of three-dimensional (3D) printing.

### BRIEF SUMMARY OF THE INVENTION

The present invention includes cartridges for use in printing one or more 3D objects in a volume of a photohardenable composition. The present invention also includes systems and methods including a cartridge in accordance with the present invention.

In accordance with one aspect of the present invention there is provided a cartridge for use in three-dimensional printing, the cartridge comprising: a rigid frame including a base and a plurality of structural members projecting upwardly from the base and a plurality of panels, the plurality of panels being in engagement with the frame to define a chamber for containing a volume of a photohardenable composition.

Preferably one or more of the panels is removably attached to the frame.

Preferably the rigid frame is a one-piece frame.

For use in 3D printing, at least a portion of a cartridge panel through which one or more excitations lights is directed during printing is optically transparent thereto.

Methods of forming a three dimensional object in a volume of a photohardenable composition and systems for forming a three dimensional object in a volume of a photohardenable composition which methods and systems include a cartridge comprising a rigid frame including a base and a plurality of structural members projecting upwardly from the base and a plurality of panels, the plurality of panels being in engagement with the frame to define a chamber for containing a volume of a photohardenable composition are also disclosed.

In accordance with another of the present invention, there is provided a cartridge for use in three-dimensional printing, the cartridge comprising: a rigid frame including a base and a plurality of structural members projecting upwardly from the base and a plurality of panels, the plurality of panels being in engagement with the frame to define a chamber for containing a volume of a photohardenable composition, wherein one or more of the panels is removably attached to the frame.

Frame members included in a rigid frame constructed with more than one frame member can be joined or secured together by, for example, but not limited to, screws, other fasteners, bonding materials or agents, or combinations including one or more thereof. Alternatively, the frame members can be joined or secured together by soldering, welding, or fusing techniques.

Preferably the cartridge includes a one-piece rigid frame. For example, a rigid frame can be machined from a single block of material. Additional methods of forming a one-piece frame can include shaping operations such as, for example, casting, die casting, laser powder bed fusion, and the like.

For use in 3D printing, at least a portion of a cartridge panel through which one or more excitations lights is directed during printing is optically transparent thereto.

In accordance with another aspect of the present invention, there is provided a system for forming a three dimensional object in a volume of a photohardenable composition, the system comprising:
a cartridge comprising: a rigid frame including a base and a plurality of structural members projecting upwardly from the base and a plurality of panels, the plurality of panels being in engagement with the frame to define a chamber for containing the volume of the photohardenable composition, wherein one or more of the panels is removably attached to the frame,
a stage or platform for supporting the cartridge in the system; and
one or more optical systems configured for directing one or more excitation lights into the volume included in the cartridge.

Preferably the cartridge includes a one-piece rigid frame.

In accordance with another aspect of the present invention there is provided a method of forming a three-dimensional object in a volume including a photohardenable composition, the method comprising:
(a) providing the volume including the photohardenable composition in a cartridge, the cartridge comprising: a rigid frame including a base and a plurality of structural members projecting upwardly from the base and a plurality of panels, the plurality of panels being in engagement with the frame to define a chamber for containing the volume of the photohardenable composition, wherein one or more of the panels is removably attached to the frame;
(b) directing one or more excitation lights into the volume of the photohardenable composition to a selected location in the volume to alter at least one property of the photohardenable composition at a selected location to induce a crosslinking or polymerization reaction in the photohardenable composition to at least partially form the three-dimensional object; and
(c) optionally repeating step (b) one or more times, wherein for a repeated step, the selected location is the same as or different from a previous selected location.

Preferably the cartridge includes a one-piece rigid frame.

In accordance with another aspect of the present invention, there is provided a cartridge for use in three-dimensional printing, the cartridge including a bottom wall and sidewalls configured to define a chamber for containing a photohardenable composition, wherein excitation light including one or more wavelengths is directed through at least one wall of the cartridge, and wherein a second wall of the cartridge opposite the light entry wall includes absorbing beam block characteristics for preventing the excitation light including one or more wavelengths from exiting the cartridge therethrough.

For use in 3D printing, at least a portion of a cartridge wall through which one or more excitations lights is directed during printing is optically transparent thereto.

Methods of forming a three dimensional object in a volume of a photohardenable composition and systems for forming a three dimensional object in a volume of a photohardenable composition which methods and systems include a cartridge comprising a wall includes absorbing beam block characteristics for preventing passage of excitation light are also disclosed.

The foregoing, and other aspects and embodiments described herein and contemplated by this disclosure all constitute embodiments of the present invention.

It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

It is to be understood that both the foregoing general description and the following detailed description are exemplary and explanatory only and are not restrictive of the invention as claimed.

Other embodiments will be apparent to those skilled in the art from consideration of the description, from the claims, and from practice of the invention disclosed herein.

### BRIEF DESCRIPTION OF THE DRAWINGS

In the Drawings,

FIG. 1 depicts a perspective view of an example of a cartridge in accordance with the present invention.

FIG. 2 depicts a perspective view of another example of a cartridge in accordance with the present invention.

FIG. 3A depicts a perspective view of an example of a cartridge in accordance with the present invention including an optional removable cap.

FIG. 3B depicts a perspective view of an example of a cartridge in accordance with the present invention without an optional removable cap.

FIG. 4A depicts an example of a cartridge in accordance with the present invention including a panel including a window in a removable mounting frame.

FIG. 4B provides an exploded view of a preferred construction for attaching a panel including a window in a removable mounting frame to the rigid frame to form a side of the cartridge.

FIG. 5 depicts a perspective view of another example of a cartridge in accordance with the present invention.

FIG. 6 depicts a perspective view of the back side (the side internal to the cartridge chamber) of a sidewall panel including a window with a stepped edge.

FIG. 7A depicts a perspective view of an example of a cartridge in accordance with the present invention in which the rigid frame includes a heater, shown by a cutaway of an external portion of a frame member, with only two of four interfaces (e.g., for power, temperature data) visible, and an optional alignment feature included in the base of the rigid frame.

FIG. 7B depicts a perspective view of an example of a cartridge in accordance with the present invention in which the rigid frame includes a heater (not shown) within a frame member and four interfaces (e.g., for power, temperature data) and an optional alignment feature included in the base of the rigid frame.

FIG. 8 is a schematic representation of an example of a printing system including a cartridge of the present invention.

The attached figures are simplified representations presented for purposes of illustration only; the actual structures may differ in numerous respects, particularly including the relative scale of the articles depicted and aspects thereof.

For a better understanding to the present invention, together with other advantages and capabilities thereof, reference is made to the following disclosure and appended claims in connection with the above-described drawings.

### DETAILED DESCRIPTION OF THE INVENTION

Various aspects and embodiments of the present inventions will be further described in the following detailed description.

The present invention includes a cartridges for use in printing one or more 3D objects in a volume of a photohardenable composition. The present invention also includes systems and methods for forming one or more 3D object in a volume of a photohardenable composition, which methods and systems include a cartridge in accordance with the present invention.

In accordance with one aspect of the present invention there is provided cartridge for use in three-dimensional printing, the cartridge comprising: a rigid frame including a base and a plurality of structural members projecting upwardly from the base and a plurality of panels, the plurality of panels being in engagement, preferably light tight engagement, with the frame to define a chamber, preferably a liquid tight chamber, for containing a volume of a photohardenable composition.

A rigid frame imparts increased integrity to the cartridge which can be advantageous in handling and various processing of a cartridge containing a photohardenable composition. An example of a process in which such integrity is particularly advantageous includes centrifugation of the filled cartridge, for example, to remove bubbles in the photohardenable composition prior to printing.

A cartridge can optionally further include one or more additional features described herein, including those described in connection with other aspects of the invention.

Preferably one or more of the panels is removably attached to the frame.

Preferably the rigid frame is a one-piece frame.

A cartridge can optionally further include one or more elements adapted for connection with an energy source for heating the frame.

In accordance with another aspect of the present invention, there is provided a there is provided a cartridge for use in three-dimensional printing, the cartridge comprising: a rigid frame including a base and a plurality of structural members projecting upwardly from the base and a plurality of panels, the plurality of panels being in engagement, preferably liquid tight engagement, with the frame to define a chamber, preferably a liquid tight chamber, for containing a volume of a photohardenable composition, wherein one or more of the panels is removably attached to the frame.

A cartridge can optionally further include one or more additional features described herein, including those described in connection with other aspects of the invention.

Preferably the cartridge includes a one-piece rigid frame.

Preferably the plurality of structural members projecting upwardly from the base are spaced apart.

Inclusion of one or more removable panels advantageously can facilitate replacement of a panel that becomes damaged without having to replace the entire cartridge.

When used for three-dimensional printing, it is desirable for at least a portion of at least one panel of a cartridge to comprise a material that is optically transparent to one or more selected excitation lights to be directed into the cartridge during printing.

Optionally an entire panel can comprise a material that is optically transparent to one or more selected excitation lights to be directed into the cartridge during printing.

Examples of optically transparent materials include, for example, but are not limited to, glass, quartz, fused quartz, fused silica, borosilicate glass, fluoropolymers (e.g., Teflon FEP, Teflon AF, Teflon PFA), cyclic olefin copolymers, polymethyl methacrylate (PMMA), polynorbornene, polycarbonate, sapphire, or transparent ceramic.

Preferably optically transparent material is included in a panel that is removable.

Being able to replace a damaged panels is particularly advantageous for a panel in which at least a portion of the panel includes an optically transparent material, which can typically comprise glass or another similar material which can be damaged by handling or otherwise during or as a result of use.

Determining the number of panels that include an optically transparent portion can take into consideration the number of one or more excitation lights used during printing and the orientation in which the excitation light(s) are directed into the cartridge during printing. Optionally, panels through which excitation light is not directed can also include at least a portion of optically transparent material.

Preferably a panel including an optically transparent portion is removably attached to the frame.

Preferably a removable panel comprises a mounting frame and a window. When more than one removable panel is included, more than one removable panel can include a mounting frame/window construction.

More preferably a window included in a mounting frame is optically transparent to an selected excitation light to be directed therethrough during printing.

Preferably the window in a removable panel including a mounting frame/window construction is replaceable.

Preferably the replaceable window included in a mounting frame/window construction is in liquid tight engagement with the mounting frame.

A window preferably comprises a material that is optically transparent to the excitation light.

Examples of optically transparent materials for use in a window include glass. Optically transparent windows can be constructed from a material comprising, for example, but not limited to, glass, quartz, fused quartz, fused silica, borosilicate glass, fluoropolymers (e.g., Teflon FEP, Teflon AF, Teflon PFA), cyclic olefin copolymers, polymethyl methacrylate (PMMA), polynorbornene, polycarbonate, sapphire, or transparent ceramic.

Preferably a window is constructed from optical glass.

It can desirable for a window to be constructed from a glass that resists chemicals used in the photohardenable printing composition and those used in cleaning.

It can be desirable for a window included in a panel to include stepped edges creating a raised area that extends a selected distance into the chamber to reduce the volume of resin within the chamber between a surface of the window in contact with the volume of the photohardenable composition in the chamber and an adjacent edge of an optical image projected into the chamber during printing.

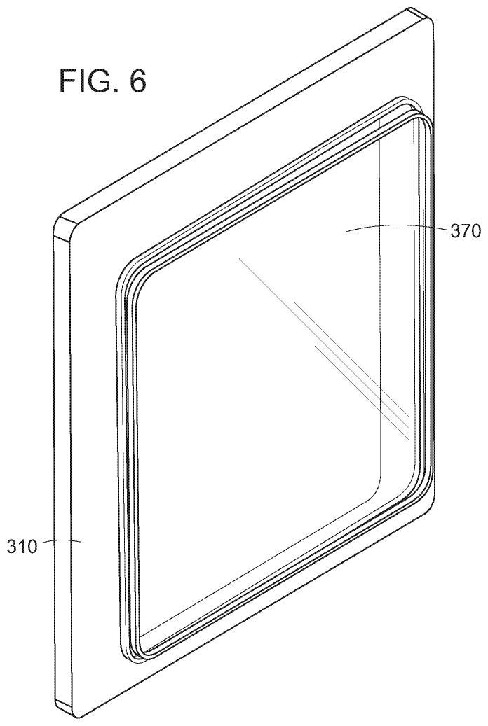

An example of a sidewall panel 310 including a mounting or window retaining frame and window with a stepped edge and raised area 370 that extends a selected distance into the chamber is depicted in FIG. 6.

It can similarly be desirable for a window included in a bottom mounting frame, when applicable, to include stepped edges creating a raised area that extends a selected distance into the chamber to reduce the volume of resin within the chamber between a surface of the bottom window in contact with the volume of the photohardenable composition in the chamber and an adjacent edge of an optical image projected into the chamber during printing.

Preferably a mounting or window retaining frame is rigid.

A rigid mounting or window retaining frame can comprise a metal (including, for example, but not limited to, aluminum, cast aluminum, low residual stress aluminum, stainless steel, copper, silver, iron, copper brass, aluminum bronze, nickel, brass, tungsten, zinc,), a metal doped or filled material, a fiber reinforced material, or the like. A rigid mounting or window retaining frame alternatively can comprise a rigid material comprising a combination of materials. A rigid mounting or window retaining frame comprising a metal can be preferred.

A mounting or window retaining frame can comprise anodized or coated metal.

The base of the frame from which a plurality of structural member project upward can be a solid base without an opening. When the base of the frame is a solid base without an opening, the solid base can serve as the bottom surface of the chamber formed in the cartridge.

Alternatively, the base can include an opening or aperture, in which case the cartridge further can further include a bottom panel to cover the aperture to form a chamber with the other panels in engagement with structural members of the rigid frame to define a chamber for containing a volume of the photohardenable composition.

When a bottom panel is included in a cartridge, the bottom panel is preferably in liquid tight engagement with the frame.

Optionally the bottom panel can be removably attached to the frame.

Optionally, the bottom panel can comprise solid panel without a window or a bottom panel can comprise a rigid bottom member including a window in liquid tight engagement with the bottom member. Optionally a window in a bottom panel can be replaceable.

In the case of a solid frame base without an opening, the base of the frame can optionally further include a raised area that extends a selected distance into the chamber to reduce the volume of resin within the chamber between a surface of the base in contact with the volume of the photohardenable composition in the chamber and an adjacent edge of an optical image projected into the chamber during printing.

Optionally one or more panels without a mounting or window retaining frame can similarly include a raised area on the surface of the panel internal to the cartridge that extends a selected distance into the chamber to reduce the volume of resin within the chamber between a surface of the base in contact with the volume of the photohardenable composition in the chamber and an adjacent edge of an optical image projected into the chamber during printing.

A rigid frame can comprise a metal (including, for example, but not limited to, aluminum, cast aluminum, low residual stress aluminum, stainless steel, copper, silver, iron, copper brass, aluminum bronze, nickel, brass, tungsten, zinc,), a metal doped or filled material, a fiber reinforced material, or the like. A rigid frame can alternatively comprise a rigid material comprising a combination of materials. A rigid frame comprising a metal can be preferred.

A rigid frame can comprise anodized or coated metal.

A rigid frame comprising aluminum can be preferred.

Preferably the rigid frame is constructed as a single piece of rigid material. Such single piece construction avoids failure of welds or other techniques used to join separate structural elements used to from the rigid frame. Such added integrity can be important in various processing of a cartridge including a volume of a photohardenable composition in connection with a process for 3D printing one or more objects therein. An example of a process in which such integrity is particularly important includes centrifugation of the filled cartridge, for example, to remove bubbles in the photohardenable composition prior to printing. Bubbles elimination from a photohardenable composition that is thixotrope is an example where centrifugation can be used. Glass cuvettes constructed from fused glass walls (e.g., without a frame) can experience damage, which damage can increase with the size of the cuvette, to the point of not being suitable for multiple reuses after being subjected to centrifugation one or more times.

A cartridge of the present invention including a rigid frame, preferably a one-piece rigid frame, advantageously can facilitate centrifuging at a speed of 1000 rpm or greater.

A cartridge of the present invention including a rigid frame, preferably a one-piece rigid frame, including a volume of a photohardenable composition can preferably withstand pressures of 78 psi or greater without leakage of the photohardenable composition from the chamber.

Depending on the size of an optically transparent region or window in a panel of a cartridge and/or the centrifuge speed used, it can be desirable to support such panel(s) during centrifugation. This is because the contents being centrifuged exert an outward pressure on the panels, which equates to an increasing outward force proportional to the panel surface area. The unsupported areas near the center of the panels may flex, potentially exceeding the flexural strength of the panel or leading to fatigue fracture of the optically transparent portion of the panel over time.

By supporting the panels during centrifugation, the outward pressure compresses rather than flexes the panels. This is a preferred stress state for many optically transparent materials.

Non-limiting examples of techniques for providing such support include a soft, spring loaded interface in the member of the centrifuge (e.g., a “bucket’ attachment) in which the cartridge is positioned during centrifugation. Such interface converts the flexing stresses to compression and avoids breakage due to flexural stress.

Examples of centrifuge speeds or cartridge sizes for which such support can be desirable include speeds above 2,000 RPM or cartridges with at least one dimension greater than, for example, 8 cm.

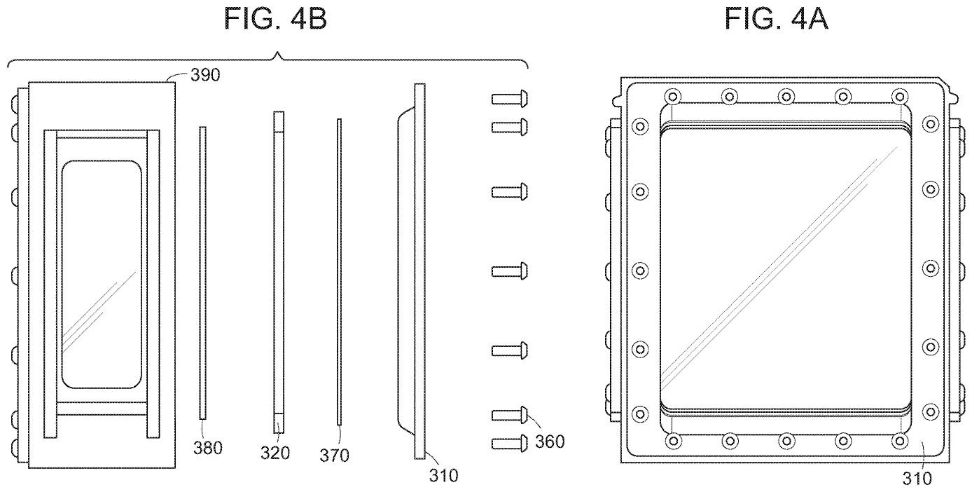

Preferably the cartridge is liquid tight or leak proof. Examples of techniques that can be used to achieve a liquid tight or leak-proof cartridge include sealing, bonding, or fusing the sidewall panels and, if applicable, a bottom wall panel, to the rigid frame. Known sealing or bonding techniques can be readily identified and adapted by the skilled artisan without undue experimentation. In another example, as described herein sidewall panels and a bottom panel (in cases in which the frame includes a bottom wall) can be retained by a bolted flange and gasket. Another example that can be preferred is shown in FIG. 4B and described herein.

A cartridge can optionally further include a machine-readable identifier. Examples of machine readable identifiers include, but are not limited to, an RFID tag or engraved 2D matrix (e.g., a QR code). Such identifiers can preferably be included in the frame. For example, an RFID tag could be embedded in the base of a frame, engraved identifiers could be engraved in the base of a frame, or alternatively in an uncovered area on the side or top of the frame. Locating such identifiers in the frame can be preferred since the frame is reusable, permitting an ID #to be reused.

Such identifiers can facilitate automatic tracking of cartridges (and optionally the parts therein) through the production process. Such tracking can be useful for efficiency tracking, quality control (e.g., for identifying problem cartridges and/or parts), and the like.

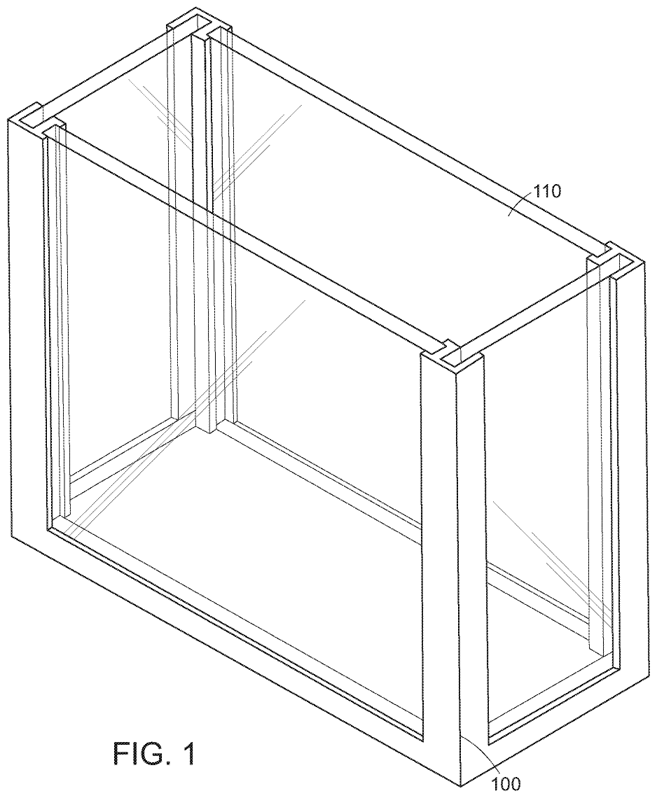

FIG. 1 depicts a perspective view of an example of a cartridge in accordance with the present invention including a rigid frame 100 including a solid base with four structural members projecting upwardly from the base and including a plurality of panels 110 that form the sidewalls of the cartridge and that are in engagement with the rigid frame to define a chamber for containing a volume of a photohardenable composition.

Preferably the panels are in liquid tight engagement with the frame to prevent leakage of the photohardenable composition from the cartridge.

Liquid tight engagement of the sidewall panels to the frame can be achieved, for example, but not limited to, sealing the panels to the frame with epoxy or other adhesive or sealant material. Alternatively a glass panel can be secured to the frame in a liquid tight manner through inclusion of a gasket between the glass and bottom and the supporting structural members for holding the panel, which is attached to the frame by fastening members.

As shown in FIG. 1, a rigid frame can optionally include channels or slots in one or more of the structural members for receiving edges of the panel to assist in creating appropriate alignment of the panels in the frame. Epoxy or other adhesive or sealant material can further be included at the edge of a panel inserted in the channel or slot to prevent unwanted leakage of photohardenable composition filled into the cartridge.

With adhesive bonding, the bond width is preferably sized to account for differential thermal expansion of the glass panels and structural frame. Because the adhesive expands more than either of the two parts being joined, the bond width is preferably sized so it can accommodate the thermal expansion differences between them.

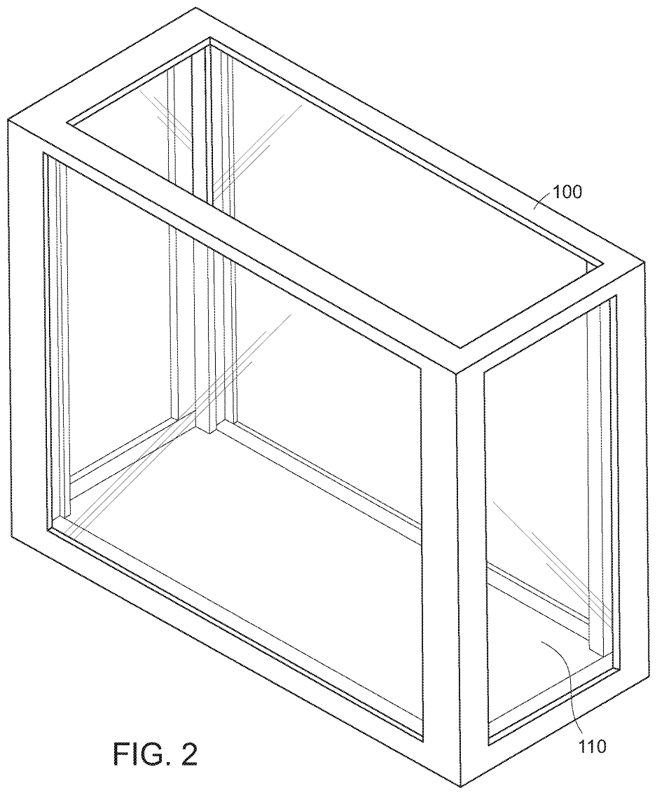

Optionally, as shown in FIG. 2, a cartridge can include a structural member at the top of the rigid frame (e.g., opposite the base) to improve the structural integrity of the cartridge. As shown, the structural members optionally further includes features to facilitate positioning and sealing the sidewall panels in the frame.

In the cartridges depicted in FIGS. 1 and 2, any one or more of the side panels can be removable. It can be desirable for each of the panels to be separately removable for repair or replacement to enhance reusability of the cartridge.

For panels that are sealed to the frame, removal can include, for example, dissolution of the sealing material with suitable solvents. Other suitable techniques can also be used.

A cartridge can have straight sides with a polygonal cross-section with the number of sidewall panels corresponding to the shape of the cross-section. In cartridges having a polygonal cross-section, the base will typically be in the shape of a polygon with structural members typically projecting upwardly from the base at points where two adjacent sides of the polygon meet.

A rectangular or square cross-section can be preferred. In the case of a cartridge having a rectangular or square cross-section, the rigid frame can include a base and structural members preferably projecting from each of the four corners of the base. While a cartridge with a rectangular cross-section can be preferred, cartridges with differently shaped cross-sections can be determined to be useful.

In a configuration in which excitation light enters two adjacent sides of the cartridge, it is highly desirable for the panels in the corresponding adjacent sides to be highly perpendicular (e.g., within 1.6 milliradian of perpendicular) to preserve light co-alignment.

A cartridge can optionally further include a separate top or cap. A separate top or cap can be removable. A separate top or cap can alternatively be removably attached to the rigid frame (e.g., by hinges, snap-locks, or the like).

A cap can be constructed from metal or plastic or combinations thereof. A cap can be optically clear.

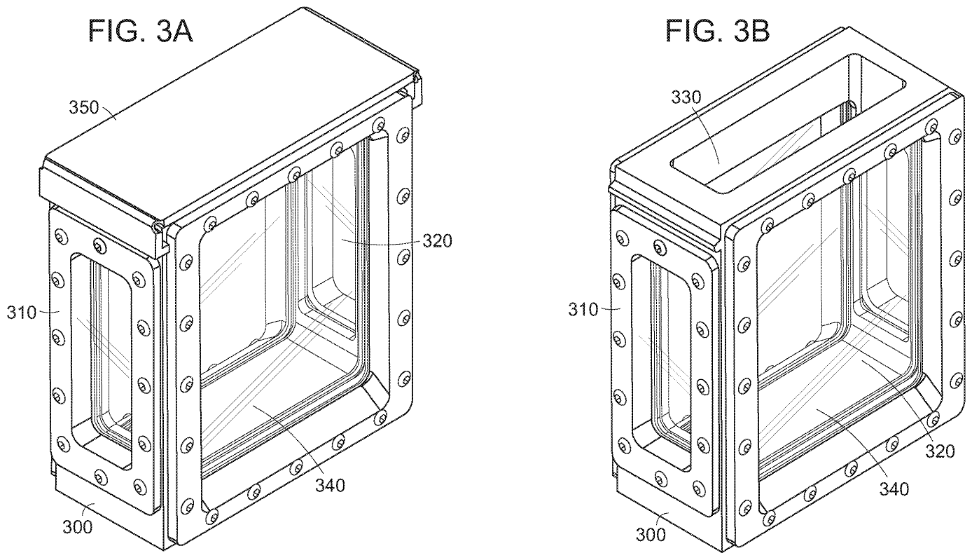

FIGS. 3A and 3B depict cartridges in accordance with the present invention that include a one-piece rigid frame 300 including a solid base 340 and including removable panels on each side that include a mounting frame 310 with a window 320. FIG. 3A depicts a cartridge in accordance with the present invention closed with an optional removable cap 350 in a locked position. As shown, the cap includes a snap lock feature on each side for locking onto the rigid frame of the cartridge. FIG. 3B depicts a cartridge in accordance with the present invention including an open top 330 without an optional removable cap.

FIG. 4A depicts an example of a removable sidewall panel including a mounting frame 310 including a window 320 in liquid tight engagement with the one-piece rigid frame and the mounting frame. As depicted in FIG. 4B, Section B-B provides an example of a preferred assembly for liquid tight engagement of the sidewall panel mounting fame and window to the rigid frame 390.

As shown, a preferred assembly for attaching the panel to the frame includes a window retaining or mounting frame 310, a window interfacing plate 370, preferably a low stress interfacing plate, a window 320, and a seal/gasket 360. The assembly is attached to the frame with fasteners (e.g., screws) 360. The mounting fame presses on the window to hold it preloaded against a seal/gasket 380. Screws or other fasteners 360 are used to apply an adequate crush load to the gasket.

Alternative fasteners include, e.g., spring clips. Alternative liquid tight seal techniques include bonding or soldering the window into a frame and use of a solvent resistance polymer or metal gasket and frame similar to the depicted preferred technique.

A mounting frame can be designed such that the external surface of the window is recessed, as shown in FIG. 4A, to prevent accidental contact with therewith during the handling of the cartridge.

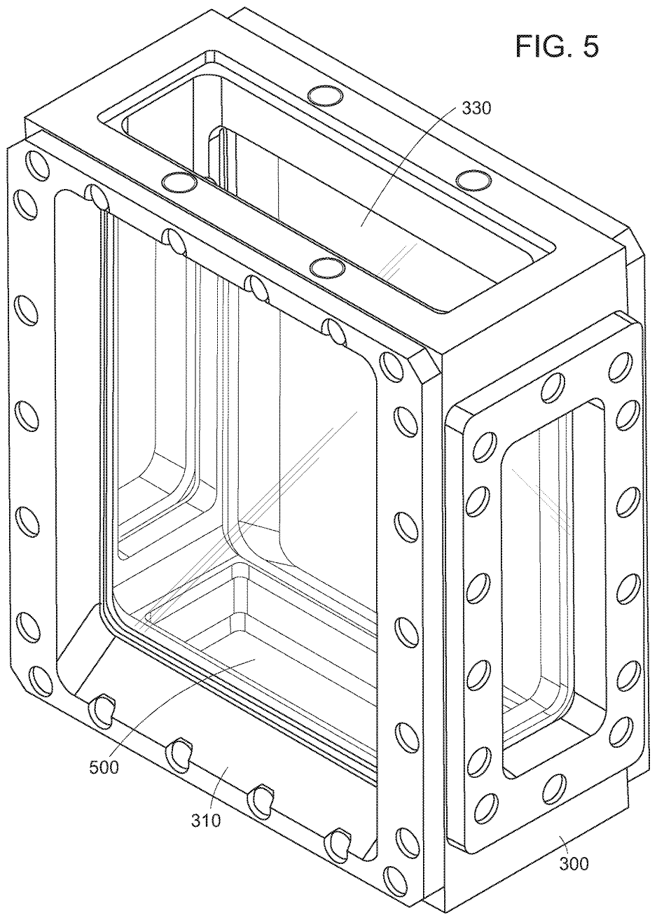

FIG. 5 depicts a cartridge in accordance with the present invention including a preferred one-piece rigid frame 300 including an opening 500 in the base and including a removable bottom panel including a window (not shown), removable panels 310 on each of the four sides of the cartridge, and an opening 330 at the top (opposite the base). As depicted, the removable panels include a mounting frame for securing a window to the rigid frame 300.

Optionally, any panel that that is not constructed from an optically transparent material or does not include a window can comprise a machined surface.

Optionally, any one or more panels that do not have excitation light directed through it can be non-optically transparent.

Preferably the optically transparent portion(s) of the container is (are) also optically flat.

Panels included in opposite sides of the cartridge are preferably of the same height. More preferably, all sidewall panels are the same height.

As discussed above, including one or more removable panels in a printing cartridge is particularly advantageous, for example, to facilitate replacement of a scratched or otherwise damaged bottom and/or sidewall panel windows, for cleaning purposes. The ability to replace a sidewall panel of a cartridge can extend the useful life of a cartridge assembly.

Additionally, it can be desirable for windows in a mounting or window retaining frame to be replaceable.

Such independently removable panels and independently replaceable windows enable more flexible printer/printing system design. For example, the cartridge can be configured for excitation light to enter/exit on any face; each sidewall panel of the same cartridge can include different types of glass and/or metal panels; sidewall panels can include different quality widows (e.g., providing a cost reduction benefit); not all panels require high tolerance different tolerances (e.g., providing a cost reduction benefit), and selected panels can have beam blocking to control back reflection and provide laser safety.

The modularity of the sidewall panels and bottom panel, if included, provide the flexibility that any such panel might comprise one of the following: optical glass that is optically transparent (with or without any type of transmissive coating); glass with a beam blocking coating; metal; metal with a beam blocking coating and/or with surface structure(s) that facilitate beam block.

The cartridge is preferably liquid tight or leak proof. Examples of techniques that can be used to achieve a liquid tight or leak-proof cartridge include sealing, bonding, or fusing a sidewall panel or, if applicable, a bottom panel, to the rigid frame.

An epoxy sealing design can also be suitable.

A preferred technique for achieving liquid tight engagement is shown in FIG. 4B.

Known sealing or bonding techniques can be readily identified and adapted by the skilled artisan without undue experimentation. In another example, a sidewall panel and a bottom panel (when applicable) can be retained by a bolted flange and gasket.

The frame, one or more panels, or the entire cartridge can be coated. For example, without limitation, one or more sides can include an anti-reflection coating, coatings to limit wavelength of light entering to one or more desired wavelengths (e.g., band pass, low pass, and/or high pass filters), hydrophobic and/or hydrophilic coatings for better cleaning, mechanically reinforcing coating, a chemical resistance coating, etc. Optionally, one or more sides can include a coating on its internal surface for enhancing the cleanability of the cartridge after it is emptied.

It can be desirable for a side of the cartridge opposite side of the cartridge through which excitation light enters the cartridge to include absorbing beam block characteristics for preventing the excitation light from exiting the cartridge through the opposite side.

A beam block can comprise, for example, a beam block coating or a beam block surface structure. A beam block coating can comprise beam block coated metal or beam block coated glass. Examples of beam block surface structures include ridges, microstructures, and the like.

Preferably the internal chamber of the cartridge has rounded corners to facilitate CNC machining and to reduce stress in the cartridge structure.

A cartridge can include grooves, slots, recesses, indentations, pegs, seating members, or the like in, for example, the base of the rigid frame and/or in the structure members projecting from the case.

Optionally, the cartridge includes features to temporarily secure the cartridge to a structural member or other component of a printer or printing system in which it is used.

Examples of other printer component includes, but is not limited to, a support structure (e.g., a stage or platform) on which the cartridge is positioned during printing.

For example, a cartridge can optionally include alignment or positioning or mounting features or a cartridge anchoring member for positioning and temporarily securing the cartridge in a printing system during printing. In such case, the printing system being used preferably includes a complementary feature (e.g., mechanisms, members, or the like) for engaging with the alignment or positioning feature of the cartridge for temporarily securing the cartridge for irradiation of the photohardenable composition included in the cartridge during formation of a 3D object with one or more excitation lights. Examples of such features or members can include, but are not limited to, alignment projections (e.g., cleats), latches, or recesses configures to temporarily or releasably engage with a complementary feature of a structural member of the apparatus for supporting and/or aligning the position of the cartridge during printing. Depending on the position of the complementary feature of the structural member of the apparatus, the matching features or member of the cartridge may be included in a side or bottom portion of the rigid frame or the top of the cartridge.

Preferably, a cartridge includes features that are complementary to features included in a printing system in which the cartridge is to be used, wherein the features comprise mechanism, members, or the like configured for temporarily or releasably engaging and positioning the cartridge at a selected position in the printing system for positional accuracy of one or more excitation lights at a selected location during printing.

A cartridge described herein can optionally further include one or more elements (e.g., heating elements) that are preferably adapted for connection with an energy source for heating the frame or maintaining the temperature of the photohardenable composition included therein at a temperature in a selected temperature range or both. (For convenience, elements adapted for connection with an energy source for heating the frame or maintaining the temperature of the photohardenable composition included therein at a temperature in a selected temperature range or both are also referred to herein as heating elements).

Inclusion of heating elements can be more effective with a rigid frame comprising a thermally conductive material.

Non-limiting examples of thermally conductive materials include metals (including, but not limited to, aluminum, stainless steel, copper, silver, iron, copper brass, aluminum bronze, nickel, brass, tungsten, zinc, thermally conductive ceramics (e.g., but not limited to, aluminum nitride, silicon carbide, and the like), and metal doped or filled materials. A rigid frame comprising a metal can be preferred.

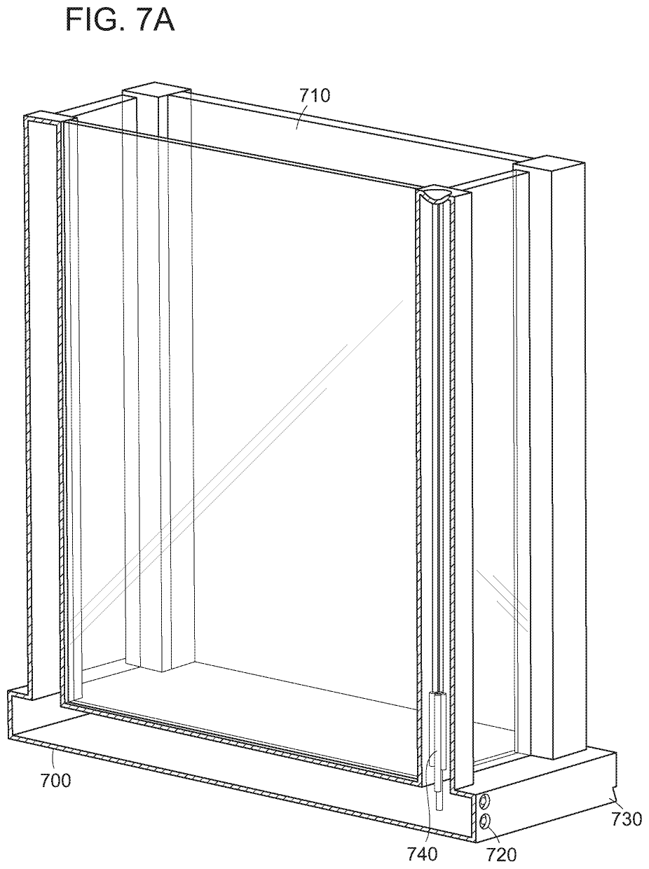

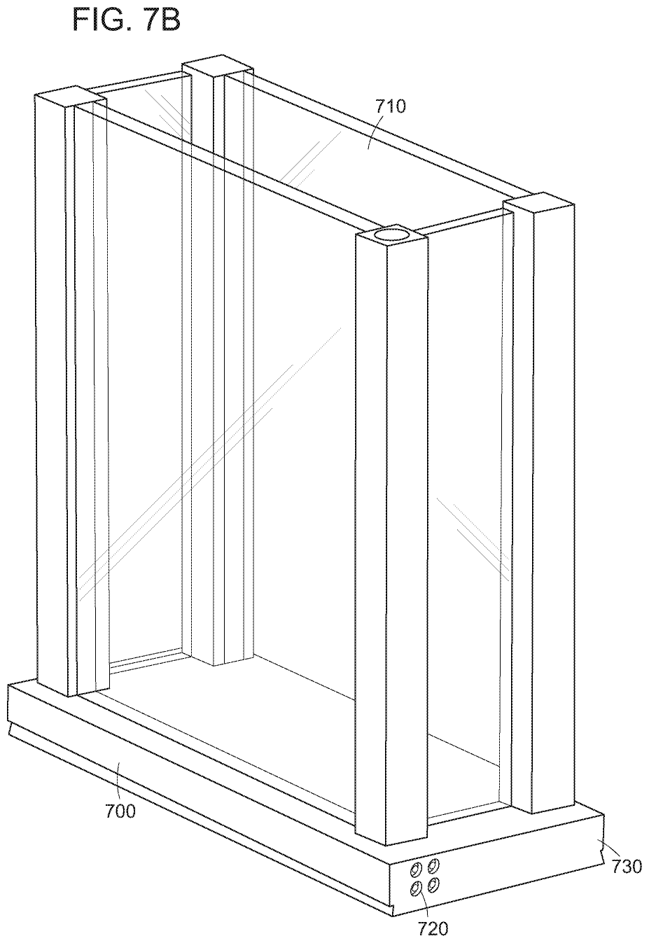

FIG. 7B depicts an example of a cartridge including a one-piece rigid frame 700 and four glass sidewall panels 710 in which a heating element (not shown) is included within the rigid frame. In the example depicted in FIG. 7B, the rigid frame includes four interfaces 720, e.g., for power and/or temperature data, and an optional alignment feature 730 in the frame base.

FIG. 7A depicts a cartridge including a one-piece rigid frame 700 and four glass sidewall panels 710. FIG. 7A depicts a cutaway view of a side of the cartridge frame 700 to show an element 740, e.g., an insertion heater, located within a structural member of the rigid frame. With the cutaway, only two 720 of the four interfaces, e.g., for power and temperature are shown. An optional alignment feature 730 in the base of the frame is also shown.

The one or more heating elements can be associated with the rigid frame in a number of different ways. For example, one or more heating elements can be included in the base or one or more structural elements of the frame or one or more sidewall panels.

Examples of heating elements that can be included in a frame member include an insertion heater or other heating element. Another example includes a heating element comprising an electrical wire included in part of the frame through which electrical current can be passed for heating the frame. Another example includes inclusion of a transparent heater (e.g., including a transparent metal on or in a bottom panel or sidewall panel of the cartridge connected to contacts included in the frame that are in further connection with an energy supply for heating a bottom panel or one or more sidewall panels of the cartridge. Such technology is known and used for heating windshields and is readily adaptable by the skilled artisan for heating a photohardenable composition during printing.

Alternatively, one or more heating elements can be included in a structural member of a 3D printer or 3D printing system with which the rigid frame is in contact during printing whereby the rigid frame is heated by heat conduction. For example, one or more heating elements for association with the rigid frame can be included in at least one of the one or more structural members of a 3D printer or 3D printing system, wherein at least a portion of the rigid frame is in contact with a structural member including the one or more heating elements. For example, in such case a structural member including one or more heating elements can be in thermal communication with side portions of a bottom frame member or other frame member of the rigid frame (e.g., a member projecting from the base portion).

Optionally one or more of the heating elements can be included in a cap and associated with a portion of the frame of the cartridge when in place on top of the cartridge.

Additionally or alternatively, one or more heating elements can be included in a support stage on which the cartridge is positioned during printing whereby the cartridge can be positioned on the support stage and the frame can be heated by heat conduction. In such case, the rigid frame is preferably in contact with the support stage for more efficient heating and one or more heating elements associated with the frame of the cartridge can be in thermal communication with a bottom portion of the frame.

Connection of a heating element to a source of electricity or other energy source can be accomplished through, for example, electrical connection to an electrical or other energy source via an electrical contact or pad, pogo pins, and the like, or via induction.

If one or more heating elements is used, it can be desirable for the elements to be in connection with a controller for the one or more heating elements for increasing and/or maintaining the temperature within the selected temperature range. An example of a temperature control unit including a sensor and a temperature sensor which is thermally coupled to the frame.

Optionally a temperature control unit can be included in a 3D printer or 3D printing system in which a cartridge associated with heating elements cartridge is included.

A photohardenable composition included in the method described herein includes a photohardenable resin component and a photoinitiator, preferably a dual wavelength photoinitiator.

Photohardenable compositions are discussed below.

The optional use of heating elements provides a way to readily heat and/or maintain the temperature of the photohardenable composition contained in the cartridge at a temperature within a selected temperature range during formation of the three dimensional object. An example of a selected temperature range includes without limitation from about 30 degrees Celsius to about 85 degrees Celsius. Preferably, the temperature of the photohardenable resin during printing is maintained at a selected temperature plus or minus about 10 degrees, more preferably at a selected temperature plus or minus about 5 degrees, and most preferably at a selected temperature plus or minus about1 degree or less.

Preferably a cartridge functions without damage at temperatures up to and including 90 degrees Celsius.

In accordance with another aspect of the present invention, there is provided a cartridge for use in three-dimensional printing, the cartridge including a bottom wall and sidewalls configured to define a chamber, preferably a liquid tight chamber, for containing the photohardenable composition, wherein excitation light including one or more wavelengths is directed through at least one wall of the cartridge, and wherein a second wall of the cartridge opposite the light entry wall includes absorbing beam block characteristics for preventing the excitation light including one or more wavelengths from exiting the cartridge therethrough.

A cartridge can optionally further include one or more additional features described herein, including those described in connection with other aspects of the invention.

Techniques for achieving absorbing beam block characteristics include, but are not limited to, a beam block coating or a beam block surface structure. A beam block coating can comprise beam block coated metal or beam block coated glass. Examples of beam block surface structures include ridges, microstructures, and the like.

At least a portion of each bottom or sidewall of the cartridge through which excitation light is directed during printing comprises a material that is optically transparent to the excitation light. Examples of optically transparent materials for use in optically transparent portions of a bottom wall or sidewall include glass. Optically transparent portions of a bottom or sidewall of a cartridge can be constructed from a material comprising, for example, but not limited to, glass, quartz, fused quartz, fused silica, borosilicate glass, fluoropolymers (e.g., Teflon FEP, Teflon AF, Teflon PFA), cyclic olefin copolymers, polymethyl methacrylate (PMMA), polynorbornene, polycarbonate, sapphire, or transparent ceramic.

Optionally, an entire bottom wall or sidewall through which excitation light is directed can be optically transparent. Optionally, any one or more of the bottom wall or sidewalls that do not have excitation light directed through it can be partly or fully constructed from an optically transparent material.

Optionally, any one or more of the bottom wall or sidewalls that do not have excitation light directed through it can be non-optically transparent.

Preferably the optically transparent portion(s) of the cartridge is (are) also optically flat.

Optionally, one or more of the bottom wall or sidewalls can be coated. For example, without limitation, one or more sides can include an anti-reflection coating, a mechanically reinforcing coating, a chemical resistance coating, etc. Optionally, one or more sides can include a coating on its internal surface for enhancing the cleanability of the cartridge after it is emptied.

The cartridge can further include a frame including a base and a plurality of structural members projecting upwardly from the base and a plurality of panels, the plurality of panels being in engagement with the frame to define the chamber. The panels can comprise the sidewalls or bottom wall of the cartridge. Optionally, the base of the frame can be solid and can serve as the bottom wall in which case a bottom wall panel would not be needed in defining the chamber in the cartridge.

Preferably the frame is a rigid frame in which the bottom wall and sidewalls are connected to the rigid frame to define a chamber for containing a photohardenable composition.

A rigid frame can comprise an assembly of rigid members. A rigid frame can optionally also include a top frame member opposite the base member which is connected to the base member by the frame side members. A cartridge can have straight sides with a polygonal cross-section with the number of sidewalls corresponding to the shape of the cross-section. A rectangular or square cross-section can be preferred. In the case of a cartridge having a rectangular or square cross-section, the base member includes four sides including two pairs of opposed sides. In such case, for example, the base member can comprise four rigid base members securely joined together at corners where two rigid base members meet. Frame members included in a rigid frame constructed with more than one frame member can be joined or secured together by, for example, but not limited to, screws, other fasteners, bonding materials or agents, or combinations including one or more of the foregoing. Alternatively, the frame members can be joined or secured together by soldering or fusing techniques.

Preferably a rigid frame is a one-piece frame. For example, a one-piece fame can be machined from a single block of material.

A rigid frame can comprise a metal (including, for example, but not limited to, aluminum, cast aluminum, low residual stress aluminum, stainless steel, copper, silver, iron, copper brass, aluminum bronze, nickel, brass, tungsten, zinc,), a metal doped or filled material, a fiber reinforced material, or the like. A rigid frame can alternatively comprise a rigid material comprising a combination of materials. A rigid frame comprising a metal can be preferred.

A rigid frame comprising a metal can be preferred.

A frame can optionally include grooves, slots, recesses, indentations, pegs, seating members, or the like in the bottom portion of the rigid frame (in embodiments where the bottom member of the rigid frame includes a bottom window) and in the frame side members in which the sidewalls with which a sidewall is fitted or held in the frame.

Optionally, a bottom wall or sidewall of a cartridge can desirably be removable, for example, to facilitate replacement of a scratched or otherwise damaged bottom wall or sidewall, for cleaning purposes. The ability to replace a bottom or sidewall of a cartridge can extend the useful life of a cartridge.

Preferably the cartridge is liquid tight or leak-proof. Examples of techniques that can be used to achieve a liquid tight or leak-proof cartridge include sealing, bonding, or fusing the sidewalls and, if applicable, a bottom wall, to the rigid frame. Known sealing or bonding techniques can be readily identified and adapted by the skilled artisan without undue experimentation. In another example, sidewalls and the bottom (in cases in which the frame includes a bottom wall) can be retained by a bolted flange and gasket. In another example, sidewalls and the bottom (in cases in which the frame includes a bottom wall) can be retained by a bolted flange and gasket.

A cartridge with a rectangular cross-section can be more preferred, cartridges with differently shaped cross-sections can be determined to be useful.

A cartridge can optionally further include a separate top. A separate top can be removable. A separate top member can alternatively be attached to the rigid frame (e.g., by hingers or the like) and openable.

Optionally, to facilitate controlling the temperature of the volume of the photohardenable composition included in a cartridge, a cartridge can further include or be adapted for association with one or more of the heating elements for connection with an energy source to facilitate heating photohardenable composition contained therein to and/or maintaining the temperature of the composition at a temperature within a selected temperature range. In such case it can be desirable for a frame to further include a sensor adapted for communication with a controller in communication with the energy source for controllably heating the frame to a temperature within a selected temperature range.

It is to be appreciated that a cartridge described herein may be sized to accommodate the number and size of the one or more 3D objects to be printed therein. Cartridge size may also take the design and size of the particular printing system into consideration.

In accordance with another aspect of the present invention there is provided a method of forming a three-dimensional object in a volume including a photohardenable composition, the method comprising:
(a) providing the volume including the photohardenable composition in a cartridge, the cartridge comprising: a rigid frame including a base and a plurality of structural members projecting upwardly from the base and a plurality of panels, the plurality of panels being in engagement with the frame to define a chamber for containing a volume of a photohardenable composition;
(b) directing one or more excitation lights into the volume of the photohardenable composition to a selected location in the volume to alter at least one property of the photohardenable composition at a selected location to induce a crosslinking or polymerization reaction in the photohardenable composition to at least partially form the three-dimensional object; and
(c) optionally repeating step (b) one or more times, wherein for a repeated step, the selected location is the same as or different from a previous selected location.

Preferably the cartridge includes a one-piece rigid frame.

Preferably one or more of the panels of the cartridge is removably attached to the frame.

Optionally, a panel of the cartridge opposite another panel through which excitation light is directed into the cartridge includes absorbing beam blocking characteristics.

In accordance with another aspect of the present invention there is provided a method of forming a three-dimensional object in a volume including a photohardenable composition, the method comprising:
(a) providing the volume including the photohardenable composition in a cartridge, cartridge comprising: a rigid frame including a base and a plurality of structural members projecting upwardly from the base and a plurality of panels, the plurality of panels being in engagement, preferably liquid tight engagement, with the frame to define a chamber, preferably a liquid tight chamber, for containing the volume of the photohardenable composition, wherein one or more of the panels is removably attached to the frame;
(b) directing one or more excitation lights from one or more optical systems into the volume of the photohardenable composition to a selected location in the volume to alter at least one property of the photohardenable composition at a selected location to induce a crosslinking or polymerization reaction in the photohardenable composition to at least partially form the three-dimensional object; and
(c) optionally repeating step (b) one or more times, wherein for a repeated step, the selected location is the same as or different from a previous selected location.

A cartridge included in the method can optionally further include one or more additional features described herein, including those described in connection with other aspects of the invention.

A method can optionally further include one or more additional features described herein, including those described in connection with other aspects of the invention.

Preferably the plurality of structural members projecting upwardly from the base are spaced apart.

Preferably the cartridge includes a one-piece rigid frame.

A panel can include a mounting or window retaining frame and a window. Preferably one or more of the removable panels includes a mounting or window retaining frame and a window, which is preferably replaceable.

Optionally, for example, for a square or rectangular cartridge, one, two, three, four of the sidewalls can be removable. For cartridges with three or more sides, any one or more of the sidewall panels can be removable.

For extending the useful lifetime of the cartridge, it can be desirable for all of the sidewall panels and bottom panel (if applicable) to be removable.

It can be desirable for walls of the cartridge through which excitation light is directed to be removable. The walls of the cartridge through which excitation light enters the cartridge will depend upon to each excitation lights used for printing and configuration of the orientation in which an excitation light is directed into the cartridge.

For example, in printing methods including two excitation lights that intersect in the volume of photohardenable composition included in the cartridge, each of the two excitation lights can be directed through ad

Preferably a window comprises a material that is optically transparent to one or more selected excitation lights.

Optionally, a panel of the cartridge opposite another panel through which excitation light is directed into the cartridge includes absorbing beam blocking characteristics.

In accordance with another aspect of the present invention, there is provided a method of forming a three-dimensional object in a volume including a photohardenable composition, the method comprising:
(a) providing the volume including the photohardenable composition in a cartridge, the cartridge including a bottom wall and sidewalls configured to define a chamber for containing a photohardenable composition, wherein excitation light including one or more wavelengths is directed through at least one wall of the cartridge, and wherein a second wall of the cartridge opposite the light entry wall includes absorbing beam block characteristics for preventing the excitation light including one or more wavelengths from exiting the cartridge therethrough;
(b) directing one or more excitation lights from one or more optical systems into the volume of the photohardenable composition to a selected location in the volume to alter at least one property of the photohardenable composition at a selected location to induce a crosslinking or polymerization reaction in the photohardenable composition to at least partially form the three-dimensional object; and
(c) optionally repeating step (b) one or more times, wherein for a repeated step, the selected location is the same as or different from a previous selected location.

A cartridge included in the method can optionally further include one or more additional features described herein, including those described in connection with other aspects of the invention.

A method can optionally further include one or more additional features described herein, including those described in connection with other aspects of the invention.

In cases in which a method includes a cartridge described herein that further includes a frame, the method can further include associating the frame of the cartridge including the volume of the photohardenable composition with one or more heating elements configured for controllably heating the frame. In such case, a method can further include controlling the temperature of the photohardenable composition included in the cartridge at a temperature wherein the temperature is within a selected temperature range during formation of the three dimensional object. It such case, it can be desirable for the method to further include a temperature control unit including a sensor and a temperature sensor thermally coupled to the frame for use in controlling the temperature.

Another aspect of the present invention includes a method of forming a three-dimensional object in a volume including a photohardenable composition, the method comprising:
(a) providing the volume including the photohardenable composition in a cartridge comprising: a rigid frame including a base and a plurality of structural members projecting upwardly from the base and a plurality of panels, the plurality of panels being in engagement with the frame to define a chamber for containing the volume of the photohardenable composition, wherein the frame preferably comprises a thermally conductive material;
(b) associating the frame of the cartridge including the volume including the photohardenable composition with one or more heating elements configured for controllably heating the frame such that the volume of the photohardenable composition included in the chamber is heated to and/or maintained at the temperature wherein the temperature is within a selected temperature range during formation of the three dimensional object;
(c) directing one or more excitation lights to a selected locations in the volume to induce a polymerization or a cross-linking reaction in the volume to form a cross-sectional slice of the three-dimensional object at a selected location; and
(d) optionally repeating step (c) one or more times, wherein for a repeated step, the selected location is the same as or different from a previous selected location and the cross-sectional slice is a successive sequential slice of the three-dimensional object being printed.

The method can further include controlling the temperature of the photohardenable composition included in the cartridge at a temperature wherein the temperature is within a selected temperature range during formation of the three dimensional object

A cartridge can optionally further include one or more additional features described herein, including those described in connection with other aspects of the invention.

A method can optionally further include one or more additional features described herein, including those described in connection with other aspects of the invention.

In accordance with another aspect of the present invention, there is provided a system for forming a three dimensional object in a volume of a photohardenable composition, the system comprising:
a cartridge comprising a rigid frame including a base and a plurality of structural members projecting upwardly from the base and a plurality of panels, the plurality of panels being in engagement with the frame to define a chamber for containing the volume of the photohardenable composition;
a stage or platform for supporting the cartridge in the system; and
one or more optical systems configured for directing one or more excitation lights into the volume included in the cartridge.

Preferably the cartridge includes a one-piece rigid frame.

Preferably one or more of the panels of the cartridge is removably attached to the frame.

Optionally, a panel of the cartridge opposite another panel through which excitation light is directed into the cartridge includes absorbing beam blocking characteristics.

A cartridge included in the system can optionally further include one or more additional features described herein, including those described in connection with other aspects of the invention.

The system can optionally further include a controller.

A system can optionally further include one or more additional features described herein, including those described in connection with other aspects of the invention.

In accordance with another aspect of the present invention, there is provided a system for forming a three dimensional object in a volume of a photohardenable composition, the system comprising:
a cartridge comprising: a rigid frame including a base and a plurality of structural members projecting upwardly from the base and a plurality of sidewall panels, the plurality of panels being in engagement, preferably liquid tight engagement, with the frame to define a chamber, preferably a liquid tight chamber, for containing a volume of a photohardenable composition, wherein one or more of the panels is removably attached to the frame,
a stage or platform for supporting the cartridge in the system; and
one or more optical systems configured for receiving and directing one or more excitation lights into the volume included in the cartridge.

A cartridge included in the system can optionally further include one or more additional features described herein, including those described in connection with other aspects of the invention.

The system can optionally further include a controller.

A system can optionally further include one or more additional features described herein, including those described in connection with other aspects of the invention.

Preferably the cartridge includes a one-piece rigid frame.

Preferably the plurality of structural members projecting upwardly from the base are spaced apart.

A panel can include a mounting or window retaining frame and a window. Preferably one or more of the removable panels includes a mounting or window retaining frame and a window, which is preferably replaceable.

A panel can include a mounting or window retaining frame and a window. Preferably one or more of the removable panels includes a mounting or window retaining frame and a window, which is preferably replaceable.

Preferably the cartridge includes at least two removably attached sidewall panels, the two panels being mounted to adjacent sides of the frame.

Preferably a window comprises a material that is optically transparent to one or more selected excitation lights.

Optionally, a panel of the cartridge opposite another panel through which excitation light is directed into the cartridge includes absorbing beam blocking characteristics.

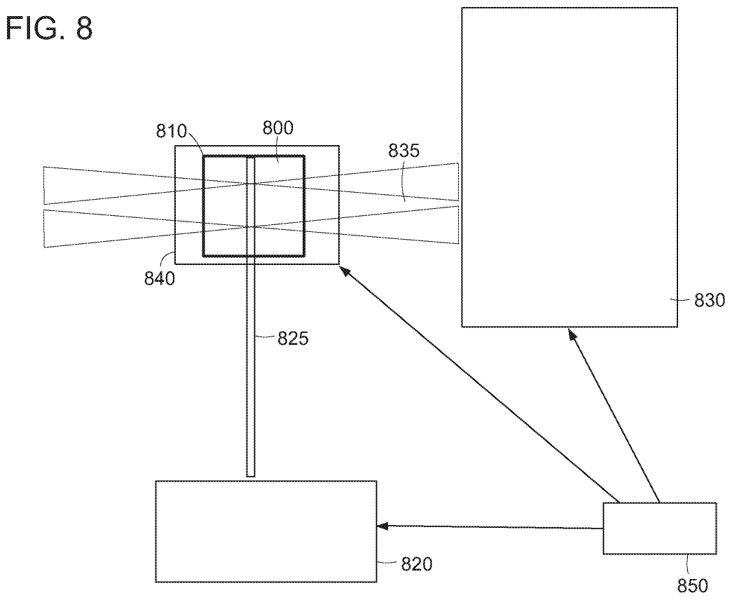

FIG. 8 depicts a diagram of an example of a system and method of the present invention including an example of a cartridge described herein. The depicted example includes a light sheet generating system 820 for generating and directing a light sheet 825 including a first wavelength to a selected location in the volume of a photohardenable composition included in the cartridge, an optical image projection system 830 for projecting an optical image 835 including a second wavelength to overlap or intersect with the light sheet at the selected location to form a cross-sectional slice of the object being printed. In the depicted example, the photohardenable composition is included in a cartridge 800 in accordance with aspects of the invention including a rigid frame 810. The cartridge 800 is positioned on a support member 840 (e.g., a support platform, a translation stage, or the like). The printing operation can be controlled through a computer 850.

While the FIG. depicts a cartridge in accordance with aspects of the invention including a rigid frame, the cartridge can alternatively comprise a cartridge in accordance with an aspect of the invention including a wall of the cartridge opposite a light entry wall, which wall includes absorbing beam block characteristics for preventing the excitation light including one or more wavelengths from exiting the cartridge therethrough, which cartridge may or may not include a rigid frame.

In accordance with another aspect of the present invention, there is provided a system for forming a three dimensional object in a volume of a photohardenable composition, the system comprising:
a cartridge including a bottom wall and sidewalls configured to define a chamber for containing a photohardenable composition, wherein excitation light including one or more wavelengths is directed through at least one wall of the cartridge, and wherein a second wall of the cartridge opposite the light entry wall includes absorbing beam block characteristics for preventing the excitation light including one or more wavelengths from exiting the cartridge therethrough,
a stage or platform for supporting the cartridge in the system; and
one or more optical systems configured for receiving and directing one or more excitation lights into the volume included in the cartridge.

A cartridge included in the system can optionally further include one or more additional features described herein, including those described in connection with other aspects of the invention.

The system can further include a controller.

A system can optionally further include one or more additional features described herein, including those described in connection with other aspects of the invention.

A system including a cartridge described herein that further includes a frame can optionally further include one or more elements (e.g., heating elements) associated with the frame for controllably heating the frame and controlling the temperature of the photohardenable composition included in the cartridge at a temperature wherein the temperature is within a selected temperature range during formation of the three dimensional object. In such case, the system can further include an energy source and a controller in operational communication (e.g., electrical, wireless, and the like) with the frame and an energy source for controlling the temperature of the photohardenable composition contained in the cartridge to a temperature within a selected temperature range, e.g., before or during printing. In such case, the frame can optionally further include a sensor in communication with the controller in communication with the energy source for controllably heating the frame to a temperature within a selected temperature range.

Another aspect of the present invention also includes a 3D printer for forming a three dimensional (3D) object in a volume of a photohardenable composition, the printer comprising:
a cartridge comprising: a rigid frame including a base and a plurality of structural members projecting upwardly from the base and a plurality of panels, the plurality of panels being in engagement with the frame to define a chamber for containing the volume of the photohardenable composition;
one or more heating elements associated with the frame of the cartridge for controllably heating the frame such that the volume of the photohardenable composition included in the chamber is heated to and/or maintained at a temperature within a selected temperature range,
at least one excitation light source for outputting a first excitation wavelength for irradiating a selected location in the volume including the photohardenable composition contained in the cartridge; and
a controller for the one or more heating elements for increasing and/or maintaining the temperature within the selected temperature range.

A cartridge can optionally further include one or more additional features described herein, including those described in connection with other aspects of the invention.

Optionally, a panel of the cartridge opposite another panel through which excitation light is directed into the cartridge includes absorbing beam blocking characteristics.

A printer can optionally further include one or more additional features described herein in connection with systems of the invention.

In methods and systems described herein, a light sheet generating system can include a light source of a first excitation light including a first wavelength, preferably a laser, from which a light sheet is generated by a light sheet generator, the light sheet including two major parallel faces that are parallel to the direction in which the light sheet is directed to a selected location in the volume. The light sheet generating system can also preferably include further light sheet optics between the light sheet generator and the cartridge.

In methods and systems described herein, a projection system can include a projector device (e.g., a DMD) and a light source in combination with illumination optics to illuminate the DMD. Such illumination optics can optionally comprise beam conditioning and condenser optics and relay optics. A light source for a second excitation light including a second wavelength illuminates the projection device. A light source comprising a non-pulsed laser or a continuous wave laser can be preferred. A projection system can further include projection optics positioned between the projector and the cartridge. Projection optics can be used for magnifying and projecting a focused an optical projection of excitation light into the cartridge. Optionally, prism(s) can be positioned between the projector and the projection optics. A projected image (typically a 2-dimensional cross-section slice of the object to be printed) is projected to the selected focal plane at the selected location in the volume. The optical image is preferably orthogonal to the direction in which it is projected into the volume.

Examples of projectors or projection devices for use in the methods and systems described herein may include, but are not limited to, a laser projection system, a liquid crystal display (also referred to herein as “LCD”), a spatial light modulator (also referred to herein as “SLM”) (for example, but not limited to, a digital micromirror device (also referred to herein as “DMD”) or a digital light processing device (also referred to herein as “DLP”)), a micro-LED array, a vertical cavity laser array (also referred to herein as “VCL”), a Vertical Cavity Surface Emitting Laser array (also referred to herein as “VCSEL”), a liquid crystal on silicon (also referred to herein as “LCOS”) projector, and a scanning laser system. (Light emitting diode is also referred to herein as “LED”.)

Examples of light sources of the excitation light that may be suitable for use in various aspects of the present invention including light sources include, by way of example and non-limitation, lasers, laser diodes, light emitting diodes, light-emitting diodes (LEDs), micro-LED arrays, vertical cavity lasers (VCLs), and filtered lamps. Such light sources are commercially available and selection of a suitable light source can be readily made by one of ordinary skill in the relevant art. Laser light sources can be preferred.

Optionally, the excitation light can be temporally and/or spatially modulated. Optionally, the intensity of the excitation light can be modulated. Optionally, source drive modulation can be used to adjust the absolute power of the light beam.

A configuration of a projector device and light source can optionally further include one or more optical components (e.g., projection optics, illumination optics, lenses, lens systems, mirrors, prisms, etc.)

Preferably the directions in which the light sheet and optical image are directed to the selected location in the volume are orthogonal to each other with the optical image and light sheet intersecting or overlapping in a coplanar manner.

In methods and systems described herein, including excitation light projected from two light sources into cartridge, at least one property of the photohardenable composition is altered to induce a cross-linking or polymerization reaction at the intersection region of the light sheet and optical image from two light sources. By moving the intersection through volume of the photohardenable composition included in the cartridge, a 3D object may be created from photohardenable composition. In such embodiments, the intersection of the may be moved with respect to cartridge. In other embodiments, the intersection may be fixed, and cartridge may be moved in order to form one or more 3D objects in the cartridge. In other embodiments, both the container and the light sheet can be moved relative to each other.

Preferably two of three of container, projector, and light sheet move to ensure that the light sheet overlaps the focal plane at the desired print plane in the photohardenable composition. The relative movement of the two moving items is determined by the refractive index of the resin.

Dual wavelength photoinitiators for inclusion in a photohardenable composition for use in the inventions described herein preferably possess photochromic properties and can be converted to a second form (or activated form) upon irradiation with light of a first wavelength, which second form can be converted to back to the first form upon irradiation with light of a second wavelength, process of cycling between these forms capable of inducing a crosslinking or polymerization reaction in the photohardenable resin component. The conversion of the photoswitchable photoinitiators described herein to a second form (or activated form) of the molecule (e.g., an isomer thereof) is preferably a reversible photochemical structural change. (Dual wavelength photoinitiators including such photochromic properties are also referred to herein as “photoswitchable photoinitiators”.)

Several considerations in selecting a particular photoswitchable photoinitiator for inclusion in a photohardenable composition or method in accordance with the present invention include, by way of example, but not limited to, the absorption spectra and Amax of the molecule and its second forms, the solubility of the photoswitchable photoinitiator in the photohardenable resin component, the photosensitivity of the second form of the photoswitchable photoinitiator, the amount of initial concentration of the second form in the monomer solution, the stability of the photoswitchable photoinitiator and the reduction and oxidation potentials of the second form of the photoswitchable photoinitiator.

Photoswitchable photoinitiators include, but are not limited to, photochromic molecules, (e.g., but not limited to, a benzospiropyran molecule, a naphthopyran molecule, a spironaphthoxazine molecule, a diarylethene molecule) which photochromic molecules can more preferably include one or more functional groups attached thereto. Such photochromic molecules can undergo an intramolecular transformation by irradiation (photochromic). Such photoswitchable photoinitiators, e.g., in the case of benzospiropyrans, naphthopyrans, and spironaphthoxazines, can function by light activated opening of the photoswitchable photoinitiator to form the activated form upon exposure to a first wavelength. In the case of diarylethenes, the activation process instead involves a ring-closing. The active form may subsequently absorb light of a different second wavelength to form an excited state of the active form which may subsequently induce photoinitiation, either alone or in combination with a coinitiator (e.g., amine, thiol, organoborate compounds, onium salts).

Preferred photohardenable compositions including a photoswitchable photoinitiator are particularly suitable for use in the methods of the present invention for forming three-dimensional objects. The photoswitchable photoinitiator molecule in its initial form and the photoinitiator molecule in its activated second form can have sufficiently distinct absorption spectra that once the initial form of the molecule is activated form, the activated form absorbs in a wavelength region where the initial form is substantially non-absorbing. In this way, the activated form can be independently excited with the second wavelength without causing unintended excitation of the initial form by the second wavelength. The second wavelength can excite the activated form to generate free radicals or otherwise induce desired hardening of the photohardenable resin component once the activated form has been generated by exposure to the first wavelength.

Preferred photoinitiators comprise a photoswitchable photoinitiator which converts from a first form with a certain absorption spectrum to a second form with a different absorption spectrum via excitation light of a first wavelength, wherein locations exposed simultaneously or near simultaneously in time with both first and second wavelength can experience a change in the resin.

Examples of photoswitchable photoinitiators suitable for inclusion in the photohardenable composition in accordance with the present invention are described in International Application No. PCT/US2022/037491, filed Jul. 18, 2022, of Quadratic 3D, Inc., U.S. Provisional Application No. 63/440,085 of Quadratic 3D, Inc., filed Jan. 19, 2023, U.S. Provisional Application No. 63/450,931 of Quadratic 3D, Inc., filed Mar. 8, 2023, International Application No. PCT/US2023/022172 of Quadratic 3D, Inc. filed May 13, 2023, U.S. Provisional Patent Application No. 63/450,936 of Quadratic 3D, Inc. filed on Mar. 8, 2023, International Application No. PCT/US2023/022173 of Quadratic 3D, Inc. filed May 13, 2023International Application No. PCT/US2022/042179, filed Aug. 31, 2022, of Quadratic 3D, Inc., International Application No. PCT/US2022/042183, filed Aug. 31, 2022, of Quadratic 3D, Inc., International Application No. PCT/US2022/042186, filed Aug. 31, 2022, of Quadratic 3D, Inc., each of the foregoing applications being hereby incorporated herein by reference in its entirety.

Other information that may be useful in connection with the various aspects of the present inventions includes International Application No. PCT/US2022/052157, filed Dec. 7, 2022, of Quadratic 3D, Inc., International Application No. PCT/US2022/039766, filed Aug. 9, 2022, of Quadratic 3D, Inc., International Application No. PCT/US2023/022171, filed May 13, 2023, of Quadratic 3D, Inc., International Application No. PCT/US2023/022896, filed May 19, 2023, of Quadratic 3D, Inc, and International Application No. PCT/US2023/022907, filed May 19, 2023, of Quadratic 3D, Inc., each of the foregoing applications being hereby incorporated herein by reference in its entirety.

Additional examples of photoswitchable photoinitiators suitable for inclusion in a photohardenable composition useful in the present invention are described in U.S. Provisional Patent Application No. 63/341,594, filed May 13, 2022, of Quadratic 3D, Inc. and International Application No. PCT/US2023/022170 of Quadratic 3D, Inc. filed May 13, 2023, which is hereby incorporated herein by reference in its entirety.

Examples of preferred photoswitchable photoinitiators for use in connection with the present invention include substituted or unsubstituted P-type photochromic molecules.

Examples of such preferred photoinitiators include, but are not limited to, substituted or unsubstituted diarylethene molecules. See, for example, International Application No. PCT/US2023/022172 of Quadratic 3D, Inc. filed May 13, 2023.

Examples of compositional ranges for a photoswitchable photoinitiator or other dual wavelength photoinitiator in a photohardenable composition include, but are not limited to, about 0.0001 to about 0.5 weight percent, including, for example, but not limited to, e.g., about 0.0001 to about 0.1 weight percent, about 0.0001 to about 0.05 weight percent, about 0.0001 to about 0.01 weight percent, about 0.0001 to about 0.009 weight percent, about 0.0001 to about 0.005 weight percent, from about 0.0001 to about 0.0025 weight percent, etc.

Examples of photoswitchable photoinitiators useful in photohardenable compositions can absorb at about 300 to 460 nm. Depending upon the absorption spectrum for the particular photoswitchable photoinitiator, the conversion to the second form can be induced by exposure to any source which emits in this range, e.g., lasers, light emitting diodes, mercury lamps.

Filters may be used to limit the output wavelengths. A non-limiting example of filtered light includes filtered emission from a mercury arc lamp, etc. The second form of the photoswitchable photoinitiator will preferably absorb in a range of about 460 to 1000 nm and 460 to 850 most typically.

A photohardenable composition can optionally include one or more coinitiators, one or more sensitizers, or one or more coinitiators and one or more sensitizers.

A photohardenable resin component suitable for inclusion in a photohardenable composition can comprise any resin (e.g., a monomer, an oligomer, a pre-polymer, a polymer, or a mixture including at least one the foregoing) that is photohardenable by exposure to light in the presence of a photoinitiator. Examples of photohardenable resin components useful for inclusion in a photohardenable composition include ethylenically unsaturated compounds and, more specifically, a polyethylenically unsaturated compounds. These compounds include both monomers having one or more ethylenically unsaturated groups, such as vinyl or allyl groups, and polymers having terminal or pendant ethylenic unsaturation. Such compounds are well known in the art and include, but are not limited to, acrylic and methacrylic esters of polyhydric alcohols such as trimethylolpropane, pentaerythritol, and the like; and acrylate or methacrylate terminated epoxy resins, acrylate or methacrylate terminated polyesters, etc. Representative examples include, but are not limited to, ethylene glycol diacrylate, ethylene glycol dimethacrylate, trimethylolpropane triacrylate (TMPTA), pentaerythritol tetraacrylate, pentaerythritol tetramethacrylate, dipentaerythritol hydroxypentacrylate (DPHPA), hexanediol-1,6-dimethacrylate, and diethyleneglycol dimethacrylate. Preferred examples include, but are not limited to, a urethane acrylate or a urethane methacrylate.

A photohardenable resin component can optionally comprise one or more multifunctional acrylate monomers. Dipentaerythritol pentaacrylate, a pentafunctional acrylic monomer available from Sartomer as SR399 is an example of a photohardenable resin component that may be desirable for inclusion in photohardenable composition of the present invention.

Aliphatic urethane acrylates may also be desirable for use as a photohardenable resin component for inclusion in a photohardenable composition described herein.

Mixtures of multifunctional acrylate monomers, such as dipentaerythritol pentaacrylate (e.g., SR399 from Sartomer), and aliphatic urethane acrylates can also be used.

A photohardenable resin component including other mixtures including one or more resin components can also be useful.

Preferably, the photohardenable resin component included in a photohardenable composition is selected to achieve an optically transparent medium, which is desirable in processes and systems in which light, e.g., excitation light, is directed into the composition or light.

Examples of particularly preferred photohardenable resin components include, but are not limited to, free-radical-polymerizable resins, cross-linkable resins, multifunctional acrylate monomers, methacrylates, aliphatic urethane acrylates, and the like.

Optionally a solvent, preferably, for example, but not limited to, an acrylamide monomer or an acrylate monomer, can be further included in a composition described herein for mixing the photoswitchable photoinitiator in the photohardenable resin component. Other suitable solvents may also be used.

A photohardenable composition can optionally include a coinitiator. (A coinitiator can also be referred to as a synergist). Optionally, one or more coinitiators can be included.

Suitable coinitiators include coinitiators which are reducing agents, oxidizing agents, or hydrogen donating compounds.

Examples of coinitiators that may be useful can be selected from among those known in the art and, more particularly, tertiary amines and organoborate salts. Iodonium salts may also be useful, particularly in combination with a borate salt. In certain embodiments, an iodonium salt may also be included in combination with a tertiary amine. Examples of other useful electron donating coinitiators are discussed by Eaton, D. F., “Dye Sensitized Photopolymerization”, Advances in Photochemistry, Vol. 13, pp 427-486.

Representative examples of N,N-dialkylanilines useful in the present invention as coinitiators include 4-cyano-N,N-dimethylaniline, 4-acetyl-N,N-dimethylaniline, 4-bromo-N,N-dimethylaniline, 4-methyl-N,N-dimethylaniline, 4-ethoxy-N,N-dimethylaniline, N,N-dimethylthioanicidine, 4-amino-N,N-dimethylaniline, 3-hydroxy-N,N-dimethylaniline, N,N,N,′N,-tetramethyl-1,4-dianiline, 4-acetamido-N,N-dimethylaniline, 2,6-diethyl-N,N-dimethylaniline, N,N,2,4,6-pentanethylaniline (PMA) and p-t-butyl-N,N-dimethylaniline.

Certain other tertiary amines are also useful coinitiators including triethylamine, triethanolamine, N-methyldiethanolamine, 2-ethyl-4-(dimethylamino)benzoate, 2-ethylhexyl-4-(dimethylamino)benzoate, etc.

Another class of useful coinitiators includes alkyl borate salts such as ammonium salts of borate anions of the formula BR^{a}R^{b}R^{c}R^{d} wherein R^{a}-R^{d} are independently selected from the group consisting of alkyl, aryl, alkaryl, allyl, aralkyl, alkenyl, alkynyl, alicyclic and saturated or unsaturated heterocyclic groups. Representative examples of alkyl groups represented by R^{a}-R^{d} are methyl (Me), ethyl, propyl, butyl, pentyl, hexyl, octyl, stearyl, etc. The alkyl groups may be substituted, for example, by one or more halogen, cyano, acyloxy, acyl, alkoxy or hydroxy groups. Representative examples of aryl groups represented by R^{a}-R^{d} include phenyl, naphthyl and substituted aryl groups such as anisyl and alkaryl such as methylphenyl, dimethylphenyl, etc.

Representative examples of aryl groups represented by R^{a}-R^{d} include benzyl. Representative alicyclic groups include cyclobutyl, cyclopentyl, and cyclohexyl groups. Examples of an alkynyl group aryl propynyl and ethynyl, and examples of alkenyl groups include a vinyl group. Preferably, at least one but not more than three of R^{a}, R^{b}, R^{c}, and R^{d} is an alkyl group. Each of R^{a}, R^{b}, R^{c}, and R^{d} can contain up to 20 carbon atoms, and they typically contain 1 to 7 carbon atoms. More preferably R^{a}-R^{d} are a combination of alkyl group(s) and aryl-group(s) or aralkyl group(s) and still more preferably a combination of three aryl groups and one alkyl group, i.e., an alkyltriphenylborate, e.g., but not limited to, a butyltriphenyl borate.

A photohardenable composition can optionally include a sensitizer. Optionally, one or more sensitizers can be included.

A sensitizer can create the excited state of the photoswitchable photoinitiator via absorbing light and transferring energy to the photoswitchable photoinitiator. For example, a sensitizer can control the sensitivity of the composition and extend the spectral sensitivity of the closed form of the photoswitchable photoinitiator. Useful sensitizers include those known in the art such as acetophenone, benzophenone, 2-acetonaphthone, isopropyl thioxanthone, alkoxyketocoumarins, Esacure 3644, and the like.

Optionally, a composition described herein can include one or more coinitiators and one or more sensitizers.

A photohardenable composition for use in the methods of the present invention preferably display non-Newtonian rheological behavior. Such rheological behavior can facilitate forming an object in a volume of a photohardenable composition upon exposure to at least two different wavelengths of excitation light wherein the object remains at a fixed position or is minimally displaced in the volume of the unhardened composition during formation. Minimal displacement refers to displacement of the object being formed during its formation in the volume that is acceptable for precisely producing the intended part geometry. Such rheological behavior can also facilitate separation of the partially hardened object from the volume in which it is formed upon application of stress. While not wishing to be bound by theory, upon the application of stress, the apparent viscosity of the non-Newtonian composition can drop to a lower value (e.g., the steady shear viscosity) than the static value (e.g., zero shear viscosity or yield stress) allowing the unhardened composition to more easily flow off and separate from the object. Examples of such non-Newtonian rheological behavior include but are not limited to pseudoplastic fluid, yield pseudoplastic, Bingham plastic, Bingham pseudoplastic rheological behavior.

Non-Newtonian rheological behavior can be imparted to a photohardenable composition by further including one or more reactive components (e.g. urethane acrylate oligomers, urethane methacrylate oligomers, acrylated or methacrylated polyurethanes, acrylated or methacrylated polyurethane-ureas, acrylated or methacrylated polyesters, acrylated or methacrylated polyamides, acrylate- or methacrylate-functional block copolymers, alkenyl- or alkynyl-functional urethane oligomers, alkenyl- or alkynyl-functional polyurethanes, alkenyl- or alkynyl-functional polyurethane-ureas, alkenyl- or alkynyl-40 functional polyesters, alkenyl- or alkynyl-functional polyamides, alkenyl- or alkynyl-functional block copolymers, thiol-functional urethane oligomers, thiol-functional polyurethanes, thiol-functional polyurethane-ureas, thiol-functional polyesters, thiol-functional polyamides, thiol-functional block copolymers) in the photohardenable resin component and/or by further adding one or more nonreactive additives (e.g., but not limited to, one or more thixotropes and/or rheology modifiers) to the composition. Selection of the one or more of reactive components and the amounts thereof for addition to a photohardenable resin component included in a photohardenable composition to impart non-Newtonian rheological behavior thereto is within the skill of the skilled artisan in the relevant art without undue experimentation. Similarly, selection of nonreactive additives and the amount(s) thereof for addition to the photohardenable composition to impart non-Newtonian rheological behavior thereto is within the skill of the skilled artisan of the relevant art without undue experimentation.

A photohardenable composition described herein can preferably have a steady shear viscosity, for example, which is less than 30,000 centipoise, less than 20,000 centipoise, less than 10,000 centipoise, less than 5,000 centipoise, less than 1,000 centipoise. (Steady shear viscosity refers to the plateau value of the viscosity achieved with unidirectional constant shear, e.g., the value of the viscosity after the thixotrope network has broken up.) Steady shear viscosities may be measured at ambient (e.g., room temperature), printing temperature, or some other temperature (e.g., elevated or reduced). Measurement at printing temperature may provide advantage in determining the suitability of a photohardenable composition for printing. Preferred steady shear viscosities are less than 30,000 centipoise, more preferably less than 10,000 centipoise, and most preferably less than 1,000 centipoise.

Steady shear viscosity can be measured under continuous constant-rate shear, such as at shear rates ranging from about 0.00001 s⁻¹ to about 1000 s⁻¹.) Photohardenable compositions can further include one or more additives. Examples of additives include, but are not limited to, a filler, a thixotrope/rheology modifier, a defoamer, a stabilizer, an oxygen scavenger, a non-reactive solvent diluent, a thermally activated radical initiator, and a colorant. Any additive can be a single additive or a mixture of additives. For example, a thixotrope can comprise a single thixotrope or a mixture of two or more thixotropes. Additional information concerning additives and non-limiting examples thereof are provided below.

Additives are preferably selected so that they do not react with other components or additives that may be included in photohardenable compositions.

As mentioned above, one example of an additive that may be included in photohardenable compositions includes a filler. Optionally a filler can include a combination of one or more fillers. A fillers can be included in an amount greater than 0 to about 90 weight percent, the amount being determined by the purpose for the filler and the desired end use characteristics for the intended three-dimensional object. Advantageously, fillers may be selected to maintain the optical transparency of the photohardenable composition, e.g., by controlling particle size to be substantially less than the excitation wavelengths or by matching the refractive indices of the filler and matrix to reduce optical scatter.

Fillers may be used to modify the properties of a hardened photohardenable composition, for example the stiffness, strength, toughness, impact resistance, resistance to creep, resistance to fatigue, mechanical energy return, mechanical loss tangent, glass transition temperature, thermal degradation temperature, thermal conductivity, thermal resistance, moisture uptake, electrical conductivity, static dissipation, dielectric constant and loss tangent, density, refractive index, optical dispersion, opacity to ionizing radiation, and resistance to ionizing radiation. Fillers may also be used to modify the properties of the liquid (e.g., unhardened) photohardenable composition, such as rheological properties such as viscosity and thixotropy and optical properties such as refractive index. Examples of fillers include but are not limited to silica, alumina, zirconia; silicates glasses such as soda-lime glass, borosilicate glass, sodium silicate glass, lead glass, aluminosilicate glass, barium glass, thorium glass, glass ceramics; chalcogenide glasses; glass microspheres and microbubbles; nanoclays such as laponite, montmorillonite, bentonite, kaolinite, hectorite, and halloysite; calcium phosphate minerals such as hydroxyapatite, mineral fillers such as chalk, rock dust, slag dust, fly ash, hydraulic cement, loess, limestone, kaolin, talc, and wollastonite. Examples of particle size ranges include but are not limited to less than 10 microns, less than 1 micron, 10 nm to 500 nm, 10 nm to 90 nm, 40 nm to 70 nm. Smaller particles sizes, in particular sizes less than about 100 nm, may be beneficial to provide high optical clarity of the liquid composition to better facilitate printing. Controlling the particle size distribution, for example monodisperse, bimodal, or trimodal distributions of sizes, may be beneficial to control rheological properties, increase filler weight percent, or modify the properties of a photohardenable composition.

Other examples of additives that may be included in photohardenable compositions include a thixotropes and rheology modifiers. Thixotropes and rheology modifiers suitable for inclusion in a photohardenable composition described herein include, for example and without limitation, urea derivatives; modified urea compounds, for example, medium polarity modified urea liquid rheology additives, such as Rheobyk 410 and Rheobyk-D 410 available from BYK-Chemie GmbH, part of the ALTANA Group; a polyamide, a urea modified polyamide, for example, high molecular weight urea modified medium polarity polyamide liquid rheology additives, such as Rheobyk 430; an amide polymer rheology modifier for medium-to high polarity liquid, fumed metal oxides (also referred to as pyrogenic metal oxides) including for example, but not limited to, fumed silica, fumed alumina; zirconia; precipitated metal oxides including for example, but not limited to, precipitated silica, precipitated alumina; unmodified and organo-modified phyllosilicate clays; dimer and trimer fatty acids; polyether phosphates; oxidized polyolefins; hybrid oxidized polyolefins with polyamide; alkali soluble/swellable emulsions; cellulosic ethers; hydrophobically-modified alkali soluble emulsions; hydrophobically-modified ethylene oxide-based urethane; sucrose benzoate; ester terminated polyamides; tertiary amide terminated polyamides; polyalkyleneoxy terminated polyamides; polyether amides; acrylamidomethyl-substituted cellulose ester polymers; polyethyleneimine; polyurea; organoclays; hydrogenated castor oil; organic base salts of a clay mineral (e.g., montmorillonite) and other silicate-type materials; aluminum, calcium, and zinc salts of fatty acids, such as lauric or stearic acid.

Fumed metal oxide thixotropes can also be used in combination with rheology additives, e.g., Rheobyk 405.

See U.S. Pat. No. 6,548,593 of Merz, et al., issued Apr. 15, 2003, and U.S. Pat. No. 9,376,602 of Walther, et al. issued Jun. 28, 2016, which are hereby incorporated herein by reference in their entireties, for information relating to urea derivatives that may be useful as thixotropes.

Thermally reversible gellants such as ester terminated polyamides, tertiary amide terminated polyamides, polyalkyleneoxy terminated polyamides, and polyether amides, and combinations thereof, may be desirable for us as thixotropes. Examples include Crystasense LP1, Crystasense LP2, Crystasense LP3, Crystasense MP, Crystasense HP4, Crystasense HP5, Rheoptima X17, Rheoptima X24, Rheoptima X38, Rheoptima X58, Rheoptima X73, and Rheoptima X84 available from Croda. Crystasense HP-5 is a preferred example of a thixotrope.

Metal oxides that have been surface-treated to impart dispersibility characteristics compatible with a photohardenable composition described herein may be desirable for use as thixotropes.

A thixotrope can be included in a photohardenable composition in an amount, for example, in a range from about 0.05 weight percent to about 15 weight percent, from about 0.5 weight percent to about 15 weight percent, from about 0.5 weight percent to about 10 weight percent from about 1 to about 10 weight percent of the composition. Other amounts may also be determined to be useful.

A thixotrope is preferably included in a photohardenable composition in an amount effective to restrict movement of the three-dimensional object or one or more regions thereof in the photohardenable composition during formation.

More preferably, the thixotrope is included in a photohardenable composition in an amount effective to restrict movement of the three-dimensional object suspended (without contact with a cartridge surface) in the volume of composition during formation. Most preferably the position of the object in the volume of the photohardenable composition remains fixed position during formation of the object.

Another example of additives that can be included in a photohardenable composition includes defoamers. A defoamer can be included to aid in removing bubbles introduced during processing and handling. A preferred defoamer is BYK 1798 (a silicone based defoamer) available from BYK-Chemie GmbH, part of the ALTANA Group.

Another example of additives that can be included in a photohardenable composition includes a stabilizer. A stabilizer can be included to improve shelf-life of the composition and/or to control the level of cure and/or spatial resolution during printing. An example of preferred stabilizer is TEMPO (2,2,6,6-tetramethylpiperidinooxy free radical available from Sigma-Aldrich). Examples of other stabilizers include, but are not limited to, hindered phenols such as butylated hydroxytoluene; hydroquinone and its derivatives such as hydroquinone methyl ether; hindered amine light stabilizers; alkylated diphenylamines; and phosphite esters.

Optionally an additive comprising a non-reactive solvent diluent can be included. Examples include, but are not limited to, acetone, amyl acetate, n-butanol, sec-butanol, tert-butanol, butyl acetate, cyclohexanone, decane, dimethylacetamide, dimethylformamide, dimethylsulfoxide, dipropylene glycol, dipropylene glycol methyl ether, ethanol, ethyl acetate, ethylene glycol, glycerol, heptane, isopropanol, isopropyl acetate, methyl ethyl ketone, N-methyl pyrrolidone, propylene carbonate, propylene glycol, propylene glycol diacetate, tetrahydrofuran, tripropylene glygol methyl ether, toluene, water, xylenes.

It may also be desirable to include a thermally activated radical initiator in a photohardenable composition. Thermally activated radical initiator examples include but are not limited to 2,2′-azobis(2-methylpropionitrile), 1,1′-azobis(cyclohexanecarbonitrile), 2,2′-azobis[N-(2-carboxyethyl)-2-methylpropionamidine] n-hydrate, 2,2′-azobis[2-methyl-N-(2-hydroxyethyl)propionamide], organic peroxides, inorganic peroxides, peroxydisulfate salts.

Unless otherwise indicated, specified weight percents are based on the total weight of the photohardenable composition.

The nature of a photohardenable resin component, the amount of the dual wavelength, and, when applicable, a coinitiator, a sensitizer, a thermally activated radical initiator, or other optional additive, included in photohardenable compositions will vary with the particular use of the compositions, the emission characteristics of the exposure sources, the development procedures, the physical properties desired in the hardened product and other factors.

Examples of photohardenable compositions in accordance with certain aspects of the invention including one or more coinitiators and/or sensitizers will generally have compositions which fall within the following compositional ranges in parts by weight [based on 100 parts total]:
Photoswitchable photoinitiator: about 0.0001 to about 0.5, including, for example, but not limited to, about 0.0001 to about 0.1, about 0.0001 to about 0.05, about 0.0001 to about 0.02, about 0.0001 to about 0.01, about 0.0001 to about 0.009, about 0.0001 to about 0.005, from about 0.0001 to about 0.0025, etc.
Coinitiators (optional) about 0.001 to about 10 including, for example, but not limited to, about 0.001 to about 7.5, about 0.001 to about 5, about 0.001 to about 2.5, about 0.001 to about 1, about 0.001 to about 0.5, from about 0.001 to about 0.25, etc.
Sensitizer (optional) about 0.1 to about 1, including, for example, but not limited to, about 0.1 to about 0.75, about 0.1 to about 0.5, about 0.1 to about 0.25, etc.
Photohardenable resin component—the balance of the photohardenable composition

Examples of photohardenable compositions in accordance with certain aspects of the invention not including one or more coinitiators and/or sensitizers will generally have compositions which fall within the following compositional ranges in parts by weight (based on 100 parts total):
Photoswitchable photoinitiator: about 0.0001 to about 0.5, including, for example, but not limited to, about 0.0001 to about 0.1, about 0.0001 to about 0.05, about 0.0001 to about 0.02, about 0.0001 to about 0.01, about 0.0001 to about 0.009, about 0.0001 to about 0.005, from about 0.0001 to about 0.0025, etc.
Photohardenable resin component—the balance of the photohardenable composition.

The weight percent of the photohardenable resin component in the above exemplary compositions can be less than 10 weight percent, e.g., less than five weight percent, less than weight percent, less than 2 weight percent, or one weight percent or less, in some cases such as printing of hydrogels where the remainder of the resin is then comprised of non-reactive components that are suspended within the final photohardened resin.

The above describes compositions and compositional ranges for non-limiting examples of photohardenable compositions in accordance with the invention. Variations of the above examples of the photohardenable composition described herein and compositional ranges for the constituents included therein may also be determined to be suitable and within the scope of the present invention.

The methods in accordance with various aspects of the invention can further include post-treatment of the three-dimensional object(s) formed.

Examples of post-treatments include, but are not limited to, removing the formed three-dimensional object from the cartridge. Following removal from the cartridge, the completed object can be further processed. Examples of further processing include, without limitation, washing, post-curing (e.g., by light, e-beam, heat, non-ionizing radiation, ionizing radiation, time (aging), pressure, humidity, or simultaneous or sequential combinations of techniques), metrology, labelling or tracking (e.g., by barcode, QR code, or RFID tag), freeze-dry processing, critical point drying, and packaging.

Preferably photoswitchable photoinitiators useful in methods for printing 3D objects in accordance with the present invention can absorb first wavelength light from about 300 nm to about 550 nm. Other examples of ranges in which the photoswitchable photoinitiator will absorb first wavelength light include, but are not limited to, from about 350 to about 460 nm, from about 350 to about 455 nm, from about 350 nm to about 445 nm, from about 350 nm to about 410 nm, from about 375 to about 455 nm, from about 375 to about 445 nm, from about 375 nm to about 405 nm. Other examples are described herein. Depending upon the extinction coefficient for the particular photoswitchable photoinitiator, the conversion to the second form can be induced by exposure to any source which emits in this range, e.g., lasers, light emitting diodes, mercury lamps. Filters may be used to limit the output wavelengths. A non-limiting example of filtered light includes filtered emission from a mercury arc lamp, etc. Lasers can be preferred sources of radiation for generating radiation of the first wavelength. The second form of the photoswitchable photoinitiator will preferably absorb second wavelength light in a range of about 450 nm to about 1000 nm, and from about 450 nm to about 850 nm most typically. Other examples of ranges in which the second form of the photoswitchable photoinitiator will preferably absorb second wavelength light include from about 450 nm to about 700 nm. This form can be activated by the second excitation light to produce free radicals directly or to produce excitons which undergo electron transfer or hydrogen abstraction (optionally via electron, hydrogen, or energy transfer to coinitiator(s) in aspects of the invention including one or more coinitiator) by exposure to any second wavelength within this range. For the second excitation, exposures may be accomplished using a laser source, an LED or LED array, the filtered emission from an arc lamp, or other suitable source with emission within the desired wavelength range. argon ion, He—Ne, laser diodes, krypton, frequency-multiplied Nd-YAG etc. Other light sources may be used, optionally with filters to limit output wavelengths, e.g., light emitting diodes, incandescent lamps, halogen lamps, mercury lamps, arc lamps, etc. Lasers can be preferred sources of radiation for generating radiation of the second wavelength.

As used herein a wavelength can refer to a wavelength or range of wavelengths.

Excitation light may be visible light, ultraviolet light, or other suitable forms of electromagnetic radiation.

In methods and systems described herein, each wavelength is preferably generated by a different light source or different optical projection or other optical systems.

The radiation or excitation source is preferably selected to emit radiation at a wavelength or within a range of wavelengths absorbed by the particular photoinitiator, e.g., the photoswitchable photoinitiator.

A light sheet can be constructed by means known in the art including, for example, but not limited to, techniques including a laser and a Powell lens, galvanometer, and/or polygon scanning mirror. Alternatively, one or more LEDs can be used as a light source.

An optical system can be selected to apply continuous excitation light. An optical system can be selected to apply intermittent excitation light. Intermittent excitation can include random on and off application of light or periodic application of light. Examples of periodic application of light includes pulsing. An optical system can be selected to apply a combination of both continuous excitation light and intermittent light, including, for example, an irradiation step that includes the application of intermittent excitation light that is preceded or followed by irradiation with continuous light.

An optical projection system can further include one or more additional components including, but not limited to, one or more translational stages for moving the system or components thereof.

In methods and systems described herein, power densities or intensities of excitation light directed into the volume of photohardenable composition to cause partial hardening (e.g., by polymerization, crosslinking) to occur at the one or more selected locations may be, without limitation, in a range from about 0.01 to about 100,000 W/cm².

Other power densities or intensities may also be determined to be useful.

In the methods and systems described herein, the cartridge optionally may be rotated to provide additional angles of illumination or projection of excitation light into the volume of photohardenable composition contained therein. This can be of assistance in patterning object volumes or surfaces more accurately or it can be used as a means of providing multiple exposure of a given feature from different angles.

In the method and systems described herein, the cartridge optionally may be stationary while a beam or optical projection of excitation light is being directed into the volume of the printing composition. Alternatively, the position of the cartridge may be translated or moved during excitation while a beam and/or optical projection of excitation is being directed into the volume of the printing composition.

Before printing, a digital file of the object or object to be printed is obtained. If the digital file is not of a format that can be used to print the object, the digital file is then converted to a format that can be used to print the object. An example of a typical format that can be used for printing includes, but is not limited to, an STL file. Typically, the STL file is then sliced into two-dimensional layers with use of three-dimensional slicer software and converted into G-Code or a set of machine commands, which facilitates building the object. See B. Redwood, et al., “The 3D Printing Handbook—Technologies, designs applications”, 3D HUBS B.V. 2018.

Other information concerning optical systems that may useful in connection with the various aspects of the present inventions includes Texas Instruments Application Report DLPA 022-July 2010 entitled “DLP™p System Optics”; Texas Instruments “TI DL^{R} Technology for 3D Printing—Design scalable high-speed stereolithography [sic] systems using TI DLP technology” 2016; Texas Instruments “DLP 6500 0.65 1018p MVSP Type A DMD”, DLP 6500, DLPS 040A-October 2014—Revised October 2016; and Y-H Lee, et al., “Fabrication of Periodic 3D Nanostructuration for Optical Surfaces by Holographic Two-Photon-Polymerization”, Int'l Journal of Information and Electronics Engineering, Vol 6, No. 3, May 2016, each of the foregoing being hereby incorporated herein by reference in its entirety.

The 3D printing method described herein does not require adhering the object being printed to a fixed substrate (e.g., build plate) at the beginning of the printing process avoiding a post-processing step of separating the printed object from the fixed substrate. It additionally facilitates printing three-dimensional objects in a volume of photopolymerizable liquid without requiring support structures to form a printed object. Post-processing steps of removing support structures and/or removing the printed object from a fixed substrate add labor (e.g., manual removal), waste (discarded support structures), and reduce throughput (a build plate cannot be reused until the printed object is removed), all of which add cost to the process.

When used as a characteristic of a portion of a cartridge or build chamber, “optically transparent” refers to having high optical transmission to the wavelength of light being used, and “optically flat” refers to being non-distorting (e.g., optical wavefronts entering the portion of the cartridge or build chamber remain largely unaffected).

As used herein, the singular forms “a”, “an” and “the” include plural unless the context clearly dictates otherwise. Thus, for example, reference to an emissive material includes reference to one or more of such materials.

Applicant specifically incorporates the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1. A cartridge for use in three-dimensional printing, the cartridge comprising: a rigid frame including a base and a plurality of structural members projecting upwardly from the base and a plurality of panels, the plurality of panels being in liquid tight engagement with the frame to define a chamber for containing a volume of a photohardenable composition, wherein one or more of the panels is removably attached to the frame, and wherein the panels comprise one or more sidewalls and optionally a bottom wall of the cartridge.

2. (canceled)

3. The cartridge of claim 1 wherein one or more panels include a mounting frame and a window, wherein the window comprises a material that is optically transparent to one or more selected excitation lights.

4. The cartridge of claim 1 wherein the rigid frame is a one-piece rigid frame.

5-6. (canceled)

7. The cartridge of claim 1 wherein one or more of the removably attached panels include a mounting frame and a window, wherein the window comprises a material that is optically transparent to one or more selected excitation lights.

8. The cartridge of claim 1 wherein the rigid frame comprises metal.

9. The cartridge of claim 1 wherein the rigid frame comprises anodized or coated metal.

10-14. (canceled)

15. The cartridge of claim 1 further including a cap.

16-20. (canceled)

21. The cartridge of claim 1 wherein the base includes an opening and the cartridge further includes a bottom panel removably attached to base, and the removably attached bottom panel includes a rigid bottom frame including a replaceable bottom window in liquid tight engagement with the bottom frame forming a liquid-tight window in the bottom panel.

22. (canceled)

23. The cartridge of claim 1 wherein the cartridge including the photohardenable composition can withstand centrifuging at a speed of 1000 rpm or greater.

24. The cartridge of claim 1 wherein the cartridge including the photohardenable composition can withstand pressures of 78 psi or greater without leakage of the photohardenable composition from the chamber.

25-26. (canceled)

27. The cartridge of claim 15 wherein the cap includes one or more snap-lock features for attaching the cap to the cartridge.

28. The cartridge of claim 7 wherein the window included in a panel includes stepped edges creating a raised area that extends a distance into the chamber to reduce the volume of resin within the chamber between a surface of the window in contact with the volume of the photohardenable composition in the chamber and an adjacent edge of an optical image projected into the chamber during printing.

29. The cartridge of claim 1 wherein the base of the frame includes a raised area that extends a selected distance into the chamber to reduce the volume of resin within the chamber between a surface of the base in contact with the volume of the photohardenable composition in the chamber and an adjacent edge of an optical image projected into the chamber during printing.

30. The cartridge of claim 21 wherein the window included in the bottom-panel includes stepped edges creating a raised area that extends a distance into the chamber to reduce the volume of resin within the chamber between a surface of the window in contact with the volume of the photohardenable composition in the chamber and an adjacent edge of an optical image projected into the chamber during printing.

31. The cartridge of claim 1 wherein a panel includes a selected raised area that extends a selected distance into the chamber to reduce the volume of resin within the chamber between a surface of the panel in contact with the volume of the photohardenable composition in the chamber and an adjacent edge of an optical image projected into the chamber during printing.

32-38. (canceled)

39. The cartridge of claim 1 wherein the cartridge further includes one or more features in the base for one or more of aligning, positioning, mounting, anchoring, and/or temporarily securing the cartridge in a printing system for printing.

40. The cartridge of claim 3 wherein the window through which excitation light enters or exits the cartridge includes an antireflection coating.

41. The cartridge of claim 3 wherein window through which excitation light enters or exits the cartridge includes a hydrophobic or hydrophilic coating.

42. The cartridge of claim 1 wherein a panel through which excitation light enters or exits the cartridge includes light absorbing coating.

43-51. (canceled)

52. The cartridge of claim 1 wherein the cartridge includes a first panel including an optically transparent portion through which excitation light is directed into the cartridge and a second panel opposite the first panel, wherein the second panel includes absorbing beam block characteristics for preventing the excitation light including one or more wavelengths from exiting the cartridge therethrough.

53. The cartridge of claim 1 wherein the cartridge includes features that are complementary to features in a printing system, wherein the features comprise mechanisms for releasably engaging and positioning the cartridge at a selected position in the printing system for positional accuracy of one or more excitation lights at a selected location during printing.

54-67. (canceled)

68. The cartridge of claim 1 wherein the cartridge further includes a machine-readable identifier.

69-71. (canceled)
